(19) United States
(12) Patent Application Publication
(10) Pub. No.: US 2025/0370992 A1
(43) Pub. Date: Dec. 4, 2025

(54) Methods and Systems for Improved Document Processing and Information Retrieval

(71) Applicant: Pryon Incorporated, Raleigh, NC (US)

(72) Inventors: Marie Wenzel Meteer, Arlington, MA (US); Ellen Eide Kislal, Leawood, KS (US); David Nahamoo, Great Neck, NY (US); Dominique O'Donnell, Portland, OR (US); Vaibhava Goel, Chappaqua, NY (US); Etienne Marcheret, White Plains, NY (US); Chul Sung, Fort Lee, NJ (US); Steven John Rennie, Yorktown Heights, NY (US); Igor Roditis Jablokov, Raleigh, NC (US); Soonthorn Ativanichayaphong, New York, NY (US); Ajinkya Jitendra Zadbuke, Cambridge, MA (US); Carmi Rothberg, New York, NY (US)

(21) Appl. No.: 18/640,371

(22) Filed: Apr. 19, 2024

Related U.S. Application Data
(63) Continuation of application No. PCT/US2023/027317, filed on Jul. 11, 2023.
(60) Provisional application No. 63/388,046, filed on Jul. 11, 2022.
(60) Provisional application No. 63/423,527, filed on Nov. 8, 2022.

(51) Int. Cl. G06F 16/242; G06F 16/248

(52) U.S. Cl. CPC G06F 16/2423; G06F 16/248

(57) ABSTRACT

Disclosed are methods, systems, devices, apparatus, media, and other implementations for improved search-time content retrieval performed by an information retrieval platform. The implementations include a method including determining by a searching system, at a first time instance, one or more first search results for a first query comprising one or more query terms associated with a first concept, modifying the query, based on the determined one or more first search results, to include one or more modified query terms associated with one or more concepts hierarchically related to the first concept, and determining at a subsequent time instance one or more subsequent search results for the modified query comprising the one or more modified query terms.

### CROSS REFERENCE TO RELATED APPLICATIONS

This application is a continuation of international application PCT/US2023/027317, filed on Jul. 11, 2023, which claims priority to U.S. Provisional Application No. 63/388,046, filed Jul. 11, 2022, and to U.S. Provisional Application No. 63/423,527, filed Nov. 8, 2022. The contents of each of the above-referenced applications are incorporated herein by reference in their entireties.

### BACKGROUND

This invention relates to question-answer systems to generate responses to queries submitted by a user, and in particular to approaches to achieve improved training and ingestion of machine learning Q-A systems, and improved question/query processing.

Computer users often have access to vast amounts of data, whether accessible through public networks (such as the Internet) or private networks, that the users can a search to find answers and information to specific or general queries about some topic or issue. For example, organizations often collect large number of documents that constitute a repository of information, be it administrative of technical information, that the organization's employees may access and perform searches on. For instance, a corporation may have a large library of human resource documents, which together define, in a hopefully consistent manner, the HR policies and procedures of the corporation. A user, such as a corporate employee, can search the collection of documents to answer a question, such as “how much vacation time am I entitled to?”

Depending on the level of specificity of a submitted query, the question-answer system may produce a large number of search results. The user might then be presented with an unwieldly large number of possible answers whose actual relevance and responsiveness to the submitted query can only be ascertained by reading through the answers, whether by reading short snippets or summaries presented on a search result user interface, or accessing an identified document associated with a result.

### SUMMARY

The present disclosure is directed to a machine-learning question-answering (“Q-A”) platform with improved document processing and information retrieval achieved by improved processing of data and users' queries during runtime (search-time). Several techniques relating to various aspects of improving searching accuracy (to better identify relevant hits or matches) and searching efficiency are presented herein. The various techniques and implementations that achieve more efficient search-time operations and functionality to search and retrieve relevant content searchable content, such as embedding space searchable content) include: i) approaches for backoff searches (when a submitted query is either too specific or may include search terms that are not relevant to the subject matter the query is directed to) or drilldown searches (when the submitted query is too general, and thus fails to identify a more focused subset of appropriate responses/answers), ii) query rewrite approaches (e.g., to identify, generally before executing a query, flaws or defects in the query form, and generate secondary queries that may yield better search results), iii) searches for hierarchical data collection that allow user's preferences to be taken into account when executing searches, and iv) relevance detection approaches (also referred to as follow-up question detection approaches) to determine if a query is too ambiguous and/or is an out-domain query.

Advantageously, the proposed approaches and solutions described herein improve the quality of returned search results by identifying possible alternative queries to those submitted by the user, or correcting deficiencies in the submitted queries. Those solutions include iterative refinements through disambiguation techniques, re-writing queries to generate supplemental queries, using preference information to focus on particular data collections when performing searches (e.g., imposing requirement that at least a certain percentage of query answers be determined from particular data collections, etc.), and mitigating various ambiguity issues.

Thus, in certain variations, a first method is provided that includes determining by a searching system, at a first time instance, one or more first search results for a first query comprising one or more query terms associated with a first concept, modifying the query, based on the determined one or more first search results, to include one or more modified query terms associated with one or more concepts hierarchically related to the first concept, and determining at a subsequent time instance one or more subsequent search results for the modified query comprising the one or more modified query terms.

Embodiments of the method may include at least some of the features described in the present disclosure, including one or more of the following features.

The first concept and the hierarchically related one or more concepts may be arranged in an ontology.

Modifying the query may comprise including in the modified query revised query terms to cause the searching system to search content directed to a broader concept that is at a parental hierarchical level in relation to the first concept.

Modifying the query may include modifying the query to include the revised query terms directed to the broader concept in response to a determination that fewer than a threshold number of respective one or more answer scores computed for the one or more first search results exceed a score threshold representative of a satisfactory answer.

Modifying the query may comprise including in the modified query revised one or more terms to cause the searching system to search for content directed to one or more child concepts that are at a child hierarchical level in relation to the first concept.

The first method may further include presenting to a user multiple search results for the first query. Modifying the query may include modifying the query to include drilled-down query terms determined for one of the multiple search results selected by the user.

The drilled-down query terms may be directed to concepts at a lower hierarchical level than the first concept.

The first method may further include determining after obtaining the one or more subsequent search results for the modified query whether to re-present the multiple search results for the first query or to further modify the modified query based on further drilled down concepts at a child hierarchical level of the lower hierarchical level.

Presenting to the user the multiple search results for the first query may include identifying multiple question-answer pairs relevant to the first query that are additionally associated with concepts at a next lower hierarchical level than the first concept, and presenting to the user at least some of the multiple question-answer pairs. Modifying the query to include drilled-down query terms may include modifying the query based on a question portion of a question-answer pair selected from the at least some of the multiple question-answer pairs.

The first method may further include iteratively repeating the modifying and determining of search results based on answer scores computed for respective search results in search iterations.

Modifying the query may include determining, based on a machine learning hierarchical concept-identifying model configured to generate resulting labels defined in a hierarchical ontology, the one or more hierarchical concepts from the hierarchical ontology in response to the first query.

Determining the one or more hierarchical concepts may include generating, according to a machine learning concept-identifying model located upstream to the machine learning hierarchical concept-identifying model, one or more labels representative of the first concept associated with the query, and processing the one or more generated labels using the machine learning hierarchical concept-identifying model to determine the one or more hierarchical concepts.

Modifying the query may include identifying one or more ambiguity categories associated with multiple matches from the one or more first search results, at least one of the one or more identified ambiguity categories being associated with at least some of the multiple matches and including different respective values associated with the at least some of the multiple matches, obtaining disambiguation information relevant to the at least one of the one or more identified ambiguity categories, and selecting at least one of the multiple matches based on the obtained disambiguation information relevant to the at least one of the one or more identified ambiguity categories.

Obtaining the disambiguation information may include one or more of, for example, obtaining query contextual information for the first query and/or generating prompt data to prompt a user to provide clarification information. Selecting at least one of the multiple matches may include selecting at least one of the multiple matches based, at least in part, on the query contextual information and/or on the clarification information provided by the user in response to the generated prompt data.

In some variations, a first searching system is provided that includes one or more memory storage devices to store data representation for content for one or more documents, and a processor-based controller communicatively coupled to the one or more memory storage devices. The controller is configured to determine, at a first time instance, one or more first search results for a first query comprising one or more query terms associated with a first concept, modify, based on the determined one or more first search results, the query to include one or more modified query terms associated with one or more concepts hierarchically related to the first concept, and determine at a subsequent time instance one or more subsequent search results for the modified query comprising the one or more modified query terms.

In some variations, a first non-transitory computer readable media is provided, that is programmed with instructions, executable on one or more processors of a computing system, to determine by a searching system, at a first time instance, one or more first search results for a first query comprising one or more query terms associated with a first concept, modify the query, based on the determined one or more first search results, to include one or more modified query terms associated with one or more concepts hierarchically related to the first concept, and determine at a subsequent time instance one or more subsequent search results for the modified query comprising the one or more modified query terms.

Embodiments of the first system and the first computer readable media may include at least some of the features described in the present disclosure, including at least some of the features described above in relation to the first method.

In various examples, a second method (for information retrieval responsive to query submissions) is provided that includes obtaining by a searching system a first query comprising one or more first query terms that are each associated with a respective first semantic meaning, deriving one or more secondary queries that each include at least one secondary query term with a respective secondary semantic meaning equivalent to the respective first semantic meaning of the at least one of the one or more first query terms of the first query, and performing searches for the one or more secondary queries to determine respective answer data.

Embodiments of the second method may include at least some of the features described in the present disclosure, including any of the features described in relation to the first method, system, and computer readable media, as well as one or more of the following features.

The first query may include a particular first query term with a particular first semantic meaning. Deriving the one or more secondary queries may include determining one or more supplemental queries each with respective one or more supplemental query terms different from the particular first query term, the one or more supplemental query terms each having an equivalent semantic meaning similar to the particular first semantic meaning.

Determining for each of the one or more supplemental queries the respective one or more supplemental query terms different from the particular first query term may include determining the respective one or more supplemental query terms, associated with semantic meanings equivalent to the particular first semantic meaning, based on matching the particular first query term to terms included in a pre-defined dictionary of query terms.

Determining for each of the one or more supplemental queries the respective one or more supplemental query terms different from the particular first query term may include determining the respective one or more supplemental query terms, associated with semantic meanings equivalent to the particular first semantic meaning, by identifying N-best scoring words for the particular first query term using a masked language model, where N≥1.

Performing searches for the one or more secondary queries may include executing searches for the first query, containing the particular first query term, and the one or more supplemental queries, computing matching scores for answers resulting from executing the searches for the first query and the one or more supplemental queries, and selecting one or more of the answers with respective one or more highest computed matching scores.

The first query may include multiple query terms, and deriving one or more secondary queries may include parsing the first query into multiple supplemental queries that each includes different subsets of the multiple query terms in the first query. Performing searches for the one or more secondary queries may include performing searches for the multiple supplemental queries to determine respective answer data.

Parsing the first query into the multiple supplemental queries may include analyzing the first query, including determining the multiple query terms in the first query, and identifying the multiple supplemental queries according to a determined level or relatedness between two or more of the multiple query terms in the first query.

The second method may further include computing matching scores for answers resulting from performing the searches for the multiple supplemental queries, and selecting one or more of the answers with respective one or more highest computed matching scores.

The method may further include determining statement of intent associated with at least one subset of the different subsets of the multiple query terms, and adding the determined statement of intent in a supplemental query, from the multiple supplemental queries, associated with the at least one subset of the different subsets of the multiple query terms. Adding the determined statement of intent may include prepending the statement of intent to the supplemental query.

Deriving one or more secondary queries may include determining a query-formulating expression associated with at least one query term from the one or more first query terms of the first query, and adding the determined query-formulating expression to the at least one query term to generate a supplemental query. Performing the searches for the one or more secondary queries may include performing a search for the supplemental query comprising the at least one query term and the query-formulating expression to determine answer data.

The query-formulating expression may include one or more of, for example, a statement of intent associated with at least one query term, and/or an interrogative expression.

Determining the query-formulating expression associated with the at least one query term may include determining the query-formulating expression based on the at least one query term and contextual information associated with one or more of, for example, the user and/or the first query.

Deriving one or more secondary queries may include identifying at least one pronoun from the first query terms, determining, based on contextual information associated with one or more of the user or the first query, a respective at least one proper noun corresponding to the at least one pronoun, and replacing the identified at least one pronoun in the first query with the determined respective at least one proper noun to generate a substitute query.

Deriving one or more secondary queries may include generating a paraphrase message comprising the first query and one or more required output characteristics for a resultant query paraphrasing of the first query, and providing the paraphrase message to a generative large language model system configured to generate a paraphrased query based on the first query and the one or more required output characteristics.

The second method may further include determining for at least one of the one or more secondary queries one or more tertiary queries with respective one or more tertiary query terms having respective tertiary semantic meanings equivalent to the respective secondary semantic meaning of the at least one query term of the at least one of the one or more secondary queries.

In some embodiments, a second searching system is provided that includes one or more memory storage devices to store data representation for content for one or more documents, and a processor-based controller communicatively coupled to the one or more memory storage devices. The controller is configured to obtain a first query comprising one or more first query terms that are each associated with a respective first semantic meaning, derive one or more secondary queries that each include at least one secondary query term with a respective secondary semantic meaning equivalent to the respective first semantic meaning of at least one of the one or more first query terms of the first query, and perform searches for the one or more secondary queries to determine respective answer data.

In some variations, a second non-transitory computer readable media is provided that is programmed with instructions, executable on one or more processors of a computing system, to obtain by a searching system a first query comprising one or more first query terms that are each associated with a respective first semantic meaning, derive one or more secondary queries that each include at least one secondary query term with a respective secondary semantic meaning equivalent to the respective first semantic meaning of the at least one of the one or more first query terms of the first query, and perform searches for the one or more secondary queries to determine respective answer data.

Embodiments of the second system and the second computer readable media may include at least some of the features described in the present disclosure, including at least some of the features described above in relation to the first and second methods, and the first system and the first computer-readable media.

In some embodiments, a third method is provided that includes obtaining query data to search a question-and-answer (Q-A) searching system storing content organized in a plurality of data collections, the query data including one or more query terms, and performing a search according to the obtained query data to determine answer data from the content in the plurality of data collections based on matching criteria for the one or more query terms and the content in the plurality of data collections, and further based on preference data indicating preferences for producing responses to the query data from the respective ones of the plurality of data collections.

Embodiments of the third method may include at least some of the features described in the present disclosure, including any of the features described in relation to the first and second methods, systems, and computer readable media, as well as one or more of the following features.

Performing the search may include computing matching scores for identified answers determined from the search according to closeness criteria applied to the query terms and the content in the plurality of data collections, and weighing the computed matching scores for the identified answers according to the preference data.

Performing the search may include computing, according to a proportionality formulation applied to the preference data, answer-proportion-values representative of proportions of answers produced from content in respective ones of the plurality of data collections, and outputting result data comprising answers selected from the plurality of data collections according to the computed proportions for the respective ones of the plurality of data collections.

Performing the search may include computing for each of the plurality of data collections a respective weight value according to a weight formulation based on the preference data or proportion value, weighing matching scores of the determined answer data based on the respective weight value applied according to which of the plurality of data collections the answers were determined from, and outputting result data comprising a pre-determined number, N, of answers having highest weighted scores.

The preference data may include one or more of, for example, identification of data collections, specified user preferences of searchable content, accessibility of the identified data collections, priority information associated with the identified data collections, identification of the one or more users associated with the query data, access permission information for plurality of data collections, and/or contextual information for the query.

At least part of the preference data may be dynamically adjustable via an interactive user interface.

Performing the search may include applying the search to at least one of the plurality of data collections to identify matching answers satisfying one or more matching criteria, and, in response to determining that there are fewer identified matching answers than a pre-determined threshold, applying the search to other collections in the plurality of data collections.

The at least one of the plurality of data collections may correspond to proprietary, non-public, data collection belonging to an organization.

Performing the search may include performing a fast search on low resolution transformed data representations of the content stored in the Q-A system, to identify candidate answers with respect to which a detailed resolution data representations is available, selecting from the identified candidate answers a subset of preferred candidate answers based on the preference data, and performing a detailed resolution search on the content stored in the Q-A system according to the subset of preferred candidate answers.

Selecting the subset of preferred candidate answers may include determining preference data percentage values associated with respective ones of the plurality of data collections, computing for each of the plurality of data collection a number-of-answers-value corresponding to the respective one of preference data percentage values applied to a pre-determined number, N, representative of a total number of answers to include in the subset of preferred candidate answers, and selecting from each of the plurality of data collection a respective computed number-of answers-value candidate answers having top matching scores.

The third method may further include determining, based on the preference data, a priority list of an order at which to search the plurality of data collections. Performing the search may include determining search matches with computed matching scores exceeding a pre-determined score threshold from one or more data collections of the plurality of data collections according to the order specified in the priority list, and returning a maximum of a pre-determined threshold number of search matches such that lower priority data collections specified in the priority list are searched only when a number of returned matches from higher priority data collections is less than the maximum pre-determined threshold number.

In some examples, a third question-and-answer (Q-A) searching system is provided that includes one or more memory storage devices, and a processor-based controller communicatively coupled to the one or more memory storage devices. The controller is configured to obtain query data to search the Q-A searching system storing content organized in a plurality of data collections, the query data including one or more query terms, and perform a search according to the obtained query data to determine answer data from the content in the plurality of data collections based on matching criteria for the one or more query terms and the content in the plurality of data collections, and further based on preference data indicating preferences for searching responses to the query data from the respective ones of the plurality of data collections.

In some embodiments, a third non-transitory computer readable media is provided, that is programmed with instructions, executable on one or more processors of a computing system, to obtain query data to search a question-and-answer (Q-A) searching system storing content organized in a plurality of data collections, the query data including one or more query terms, and perform a search according to the obtained query data to determine answer data from the content in the plurality of data collections based on matching criteria for the one or more query terms and the content in the plurality of data collections, and further based on preference data indicating preferences for searching responses to the query data from the respective ones of the plurality of data collections.

Embodiments of the third system and the third computer readable media may include at least some of the features described in the present disclosure, including at least some of the features described above in relation to the first and second methods, systems, and computer-readable media, and the third method.

In some variations, a fourth method is provided that includes obtaining a query to identify possible answers in a question-and-answer (Q-A) system for storing and retrieving content, applying a classification procedure to the query to classify the query according to at least one of, for example, whether the query is ambiguous, whether the query is directed to in-domain content, and/or whether the query is directed to out-domain content, and processing the query according to a determined class for the query.

Embodiments of the fourth method may include at least some of the features described in the present disclosure, including any of the features described in relation to the first, second, and third methods, systems, and computer readable media, as well as one or more of the following features.

Applying the classification procedure may include transforming the query into a query vector representation according to a language model transform, and classifying the query vector representation into one of a plurality of classes.

Processing the query may include obtaining, in response to a determination that the query is classified as being in-domain and ambiguous, clarification information to reduce ambiguity of the query.

Processing the query may include performing a searching operation for the query in response to a determination that the query is classified as being non-ambiguous and directed to in-domain content.

Applying the classification procedure may include applying a machine learning classification procedure to the query.

Applying the classification procedure may include determining contextual information for the query, and applying the classification procedure based on the query and the contextual information.

The contextual information may include at least one of, for example, one or more preceding queries submitted to the Q-A system, contextual data associated to the query, and/or contextual data associated with a user submitting the query.

Applying the classification procedure to the query may include computing in-domain and generic domain probabilities for the query under two or more different N-gram language models, deriving a metric based on the computed probabilities, and determining whether the query is an in-domain or out-domain query based on the derived metric.

Deriving the metric may include deriving a log-likelihood ratio of the in-domain and generic probabilities.

Determining whether the query is an out-domain query may include comparing the derived metric to a pre-established out-domain threshold.

In some embodiments, a fourth question-and-answer (Q-A) searching system is provided that includes one or more memory storage devices to store data representation for content for one or more documents, and a processor-based controller communicatively coupled to the one or more memory storage devices. The controller is configured to obtain a query to identify possible answers in the question-and-answer (Q-A) system, apply a classification procedure to the query to classify the query according to at least one of, for example, whether the query is ambiguous and/or whether the query is directed to in-domain or out-domain content, and process the query according to a determined class for the query.

In some variations, a fourth non-transitory computer readable media is provided, that is programmed with instructions, executable on one or more processors of a computing system, to obtain a query to identify possible answers in a question-and-answer (Q-A) system for storing and retrieving content, apply a classification procedure to the query to classify the query according to at least one of, for example, whether the query is ambiguous, whether the query is directed to in-domain content and/or whether the query is directed to out-domain content, and process the query according to a determined class for the query.

Embodiments of the fourth system and the fourth computer readable media may include at least some of the features described in the present disclosure, including at least some of the features described above in relation to the first, second, and third methods, systems, and computer-readable media, and to the fourth method.

Any of the above variations, examples, and embodiments of the system, methods, and/or computer readable media may be combined with any of the features of any other of the variations, examples, and embodiments, of the systems, methods, computer-readable media, and all other implementations described herein, and may also be combined with any other of the features described herein.

Other features and advantages of the invention are apparent from the following description, and from the claims.

### BRIEF DESCRIPTION OF THE DRAWINGS

These and other aspects will now be described in detail with reference to the following drawings.

FIG. 1 is a diagram of an example Question-and-Answer document processing and response generation system.

FIG. 2 is a diagram of an example document ingestion procedure.

FIG. 3 is a diagram of an example hierarchical arrangement of product-related concepts.

FIG. 4 is a flow diagram illustrating a query modification procedure to implement query backoff and drilldown operations.

FIG. 5 is a flowchart of a procedure for drill-down and backoff query modification operations.

FIG. 6 is a flow diagram illustrating an example query re-write framework to improve searching quality.

FIG. 7 is a flowchart of a procedure for information retrieval based on query re-writes of query submissions.

FIG. 8 is a flow diagram illustrating an example searching framework that uses preference data to produce search results aligned with users' likely needs and preferences.

FIG. 9 is a flowchart of a preference-based searching procedure that searches content and produces results in accordance with the submitting user's preferences (e.g., for particular data collections).

FIG. 10 is a flow diagram illustrating a searching framework with a relevance detector configured to determine ambiguity level in a submitted query and/or determine if the submitted query is in-domain.

FIG. 11 is flowchart of a query analysis and execution procedure that determines whether a query is ambiguous, and/or is directed to in-domain or out-domain content.

Like reference symbols in the various drawings indicate like elements.

### DESCRIPTION

### 1 Overview

Disclosed are implementations for a question-and-answer information retrieval system (also referred to as a question-answering system or Q-A system) that include various processes to provide new capabilities, to improve searching efficiency, and/or improve the quality of retrieved information (e.g., to improve the relevance of identified answers or responses). These processes may be used individually or in combination to provide overall improved capabilities of a Q-A system. One or more examples of Q-A systems that may be modified to include one or more of these processes are describe in International Application published as WO2021/263138, on Dec. 30, 2021, and filed on Jul. 21, 2021, as PCT/US2021/039145, titled “DOCUMENT PROCESSING AND RESPONSE GENERATION SYSTEM,” which is incorporated herein by reference.

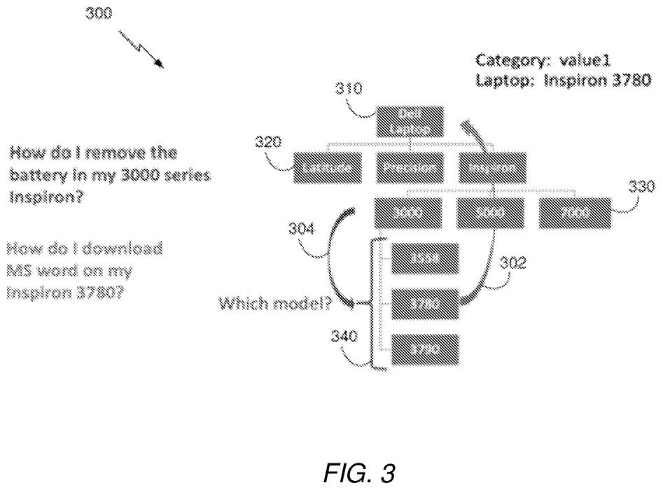

Some examples of the processes discussed herein include query drilldown and backoff processes, more particularly discussed below in relation to FIGS. 3-5, to modify queries (e.g., when the submitted query is too broad or too specific and as a result the search systems returns responses with relatively low scores, resulting in non-optimal use of computing resources) based on pre-determined dictionaries of concepts or ontologies that define a hierarchy of concepts (related to a particular subject matter, or multiple subject matters), including defining the relationship between concepts.

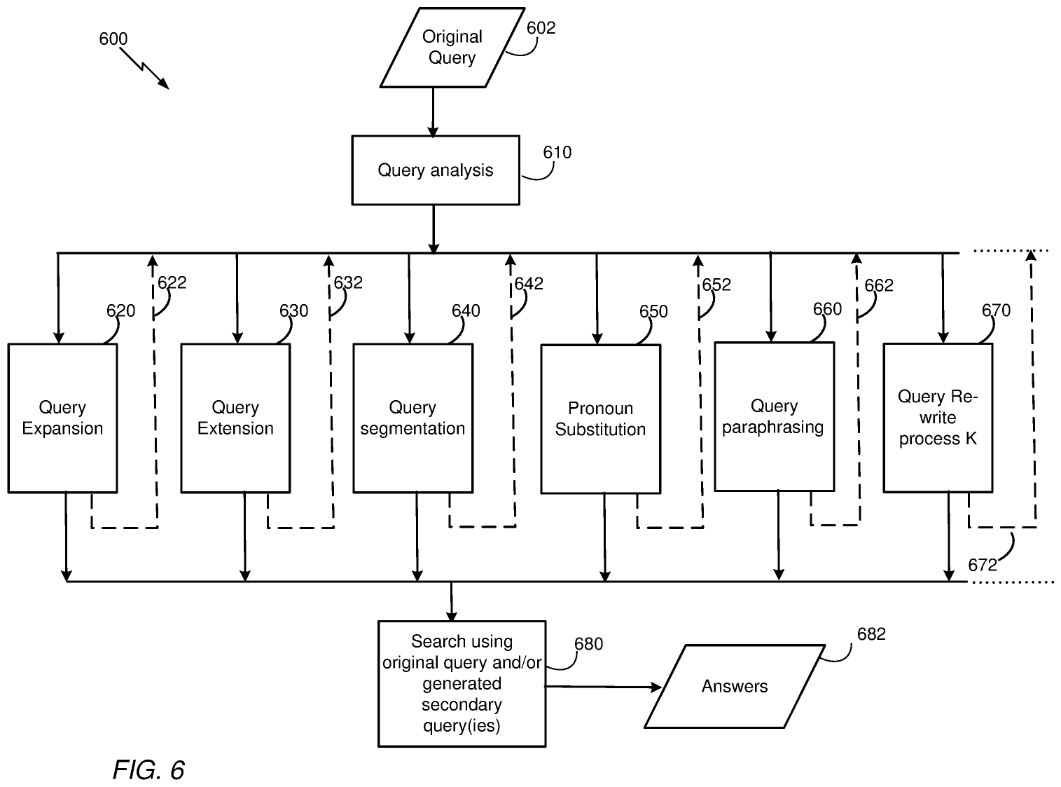

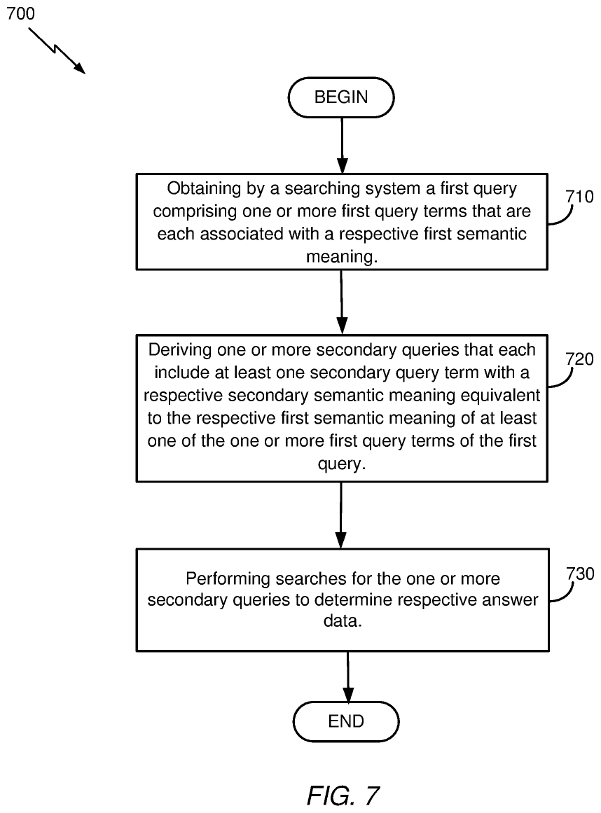

Other examples of the processes discussed herein provide solution to improve searching performance and operation using a query re-write approach, more particularly described in relation to FIGS. 6-7, under which secondary queries are generated in response to a first submitted query, with the secondary queries including query terms that are semantically equivalent to at least one of the original query terms in the first submitted query. The derivation of secondary searches allows the identification of a greater range of answers that correspond to the refined re-written queries. In a first re-write technique, as will be discussed in greater detail below, supplemental queries that use different, but semantically similar, terms to those used in the original query are generated so as to find search results that are more responsive to the semantically similar (equivalent) terms than the terms specified in the original query. This procedure is referred to as query expansion, in that it expands the number of queries, and thus expands the number of search terms, being searched. In another query re-write technique, referred to as query extension, terse queries, that may include just an isolated search term or concept, are converted into queries that have query formulating expressions (such as interrogative wording, intention language etc.) The extended query may then better match with Q-A content that has been previously created (and which is often associated with query-building expressions). The particular extension language can be determined based on contextual information associated with the submitted query, or with the user submitting the query. A third example query re-write technique discussed herein is query segmentation, in which a relatively verbose query is broken into several more concise queries that are separately searched (and as a result provide a greater number of responses, that are generally more focused than responses produced for the original verbose query).

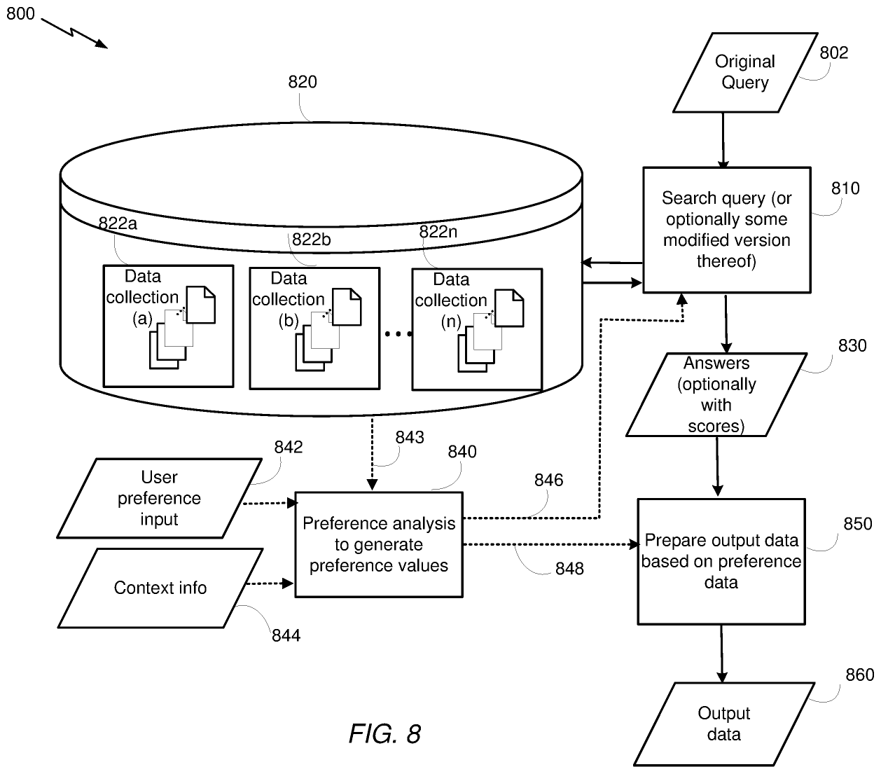

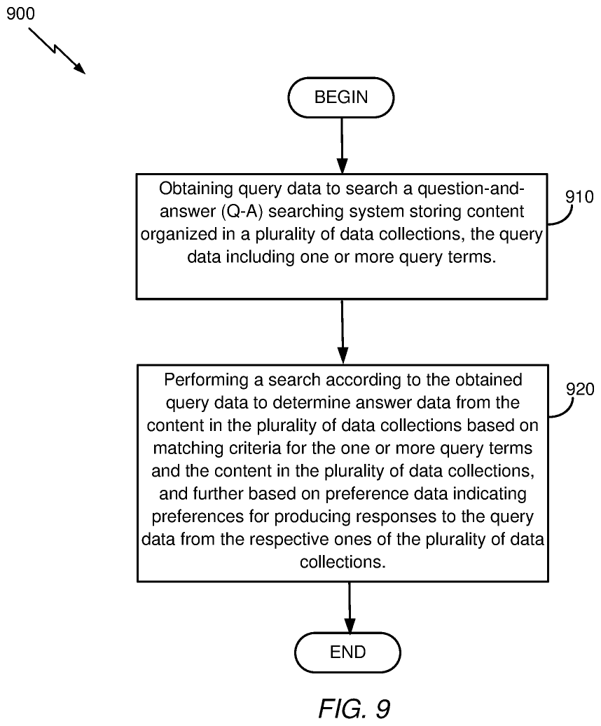

Other examples of the processes improve searching performance and the quality of produced answers/responses is a user-preferences-based solution (e.g., defining a hierarchy of data collections), more particularly described in relation to FIGS. 8-9, that performs searches in accordance with user's preferences (such as preferred data collections within the repository that should be searched, or from which a higher proportion of candidate matches should be produced). This approach allows information to be organized to optimize speed, and to disaggregate data.

Other examples of the processes relate to analyzing a query, prior to executing the query, to determine, and if possible, resolve, various issues of ambiguity related to the submitted query. For example, a relevance detector performs a quick ambiguity/relevance classifications on queries to determine if a particular query is too ambiguous to be processed, or has enough clarity to return answer results with sufficient confidence in the quality of the answers (e.g., confidence that the answers returned are not nonsensical). The question relevance detector mitigates situations where out-domain detection and follow-up questions (e.g., terse queries or questions that rely on preceding questions for context and semantic meaning) challenge the performance of the searching system. Under the question relevance detection approach, transformer technology can be used to classify the query into, for example, three (3) classes of queries, namely, complete (non-ambiguous) in-domain query, out-domain query, and ambiguous-in-domain query. Depending on the determined class of the query, different actions may next be taken by the searching system.

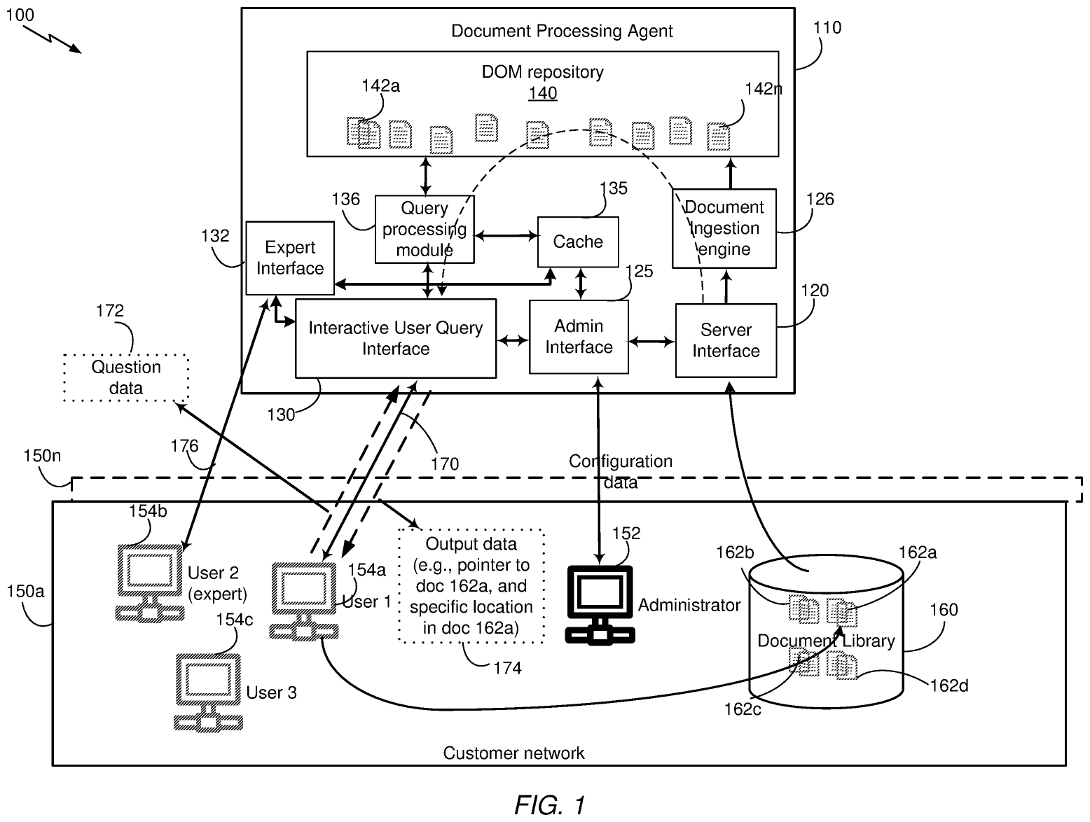

The approaches and solutions described herein may be implemented on any computing framework with searching capabilities (in the form of question-and-answers, or otherwise). For the sake of illustration only, and without limitation, some example embodiments of the improved searching approaches and solutions will be discussed in relation to the architecture depicted in FIG. 1 into which these approaches may be integrated. This architecture is described in greater detail in the following section.

### 2 Example Question-and-Answer System Architecture

With reference to FIG. 1, a diagram of an example document processing and information retrieval platform (implemented as a question-answering (Q-A) system 100) is provided. Further details regarding the system 100 are provided in international application No. PCT/US2021/039145, entitled “DOCUMENT PROCESSING AND RESPONSE GENERATION SYSTEM,” the content of which is hereby incorporated by reference in its entirety.

The system 100 is configured to ingest source documents (e.g., a customer's voluminous library of documents, or other repositories of data such as e-mail data, collaborative platform data, third-party data repositories, etc.) to transform the documents to document objects (referred to as document object model, or DOM, documents) that represent a mapping from the source documents to searchable resultant objects (resultant transformed) documents. Those document objects may be stored in a DOM repository (also referred to as knowledge distillation, or KD, repository). A user associated with the customer that provided that document library (e.g., an employee of the customer) can subsequently submit a query (e.g., a natural language query, such as “how many vacation days does an employee with 2 years seniority get a year?”) that is processed by the system 100, and, in situations where a quick answer is not otherwise available from a cache for commonly-asked-questions, the query is processed and transformed into a format compatible with the format of ingested documents to identify portions in one or more of the ingested documents that may contain the answer to the user's query. As discussed herein, in various examples the user's submitted query can be processed or analyzed (using query re-writing approaches, query backoff or drilldown approaches, user's preferences approaches, relevance and ambiguity detection approaches, etc.) to improve the searching performance and the quality of the returned responses/answers.

The system returns output data that includes, for example, a pointer to a location within one or more of the source documents (corresponding to the identified one or more ingested documents) which the user then accesses directly to retrieve an answer to the query. The output may alternatively, or additionally, include, in some embodiments, the answer to the user's query and/or a portion of a document, e.g., a paragraph, that contains the answer. Advantageously, the output returned to the user does not need to (although, in some examples, it may, if desired) include the specific information sought by the user, but rather just includes a pointer to a portion of source document stored in a secured site that cannot be accessed by parties not authorized to access that source document. This answer-determination approach therefore enhances the security features of transmitting sensitive information (e.g., confidential or private). In situations where a query produces multiple answers (some of which may have conflicting values), the output may include dynamically generated prompts asking the user to provide feedback to resolve ambiguity in the returned answers.

In certain examples, searching the document object repository to find an answer to a query typically may include a multi-pronged (e.g., two or more) procedure: (1) first, a process referred to as Fast-Search or Fast Match (FM) process is performed, and (2) the Fast-Match process is then followed by a process called Detailed-Search or Detailed-Match (DM) process (also referred to herein as “fine-detail” search). Both the FM and DM processes can be based on BERT (Bidirectional Encoder Representations from Transformers) language transform model or some other language transform model. In the FM case, the model results (in some implementations) in, for example, one vector for a query and one vector for one paragraph (e.g., 200 words window, which may also include contextual data). In the DM, there are typically multiple vectors per query or per paragraph, in proportion to the number of, for example, words or sub-words, in the query or paragraph.

It is to be noted that, in some examples, the transformations of the query and/or the source documents may be performed at a customer's network, with the transformed query and/or transformed content then communicated to a central server. Such embodiments can improve privacy and security for communicating sensitive data across networks since resultant vectors (derived through the transformation of content or query data) are created in the secure space of the customer (client), and consequently only the resultant transformed vectors (rather than the actual content or query data) are available or present at the centralized cloud server. The transformation of the content or query data at the client's device can act as a type of encryption applied to the data being transformed and will thus result in secure processing that protects the data from attacks on the server cloud. In some embodiments, the data being transformed at the client's network can additionally be encrypted to provide even further enhanced secured communication of the client's data (be it source data or query data).

As depicted in FIG. 1, the system 100 typically includes a document processing agent 110 (some modules of which may be AI-based implementations) in communication with a customer's network 150a (which is one of n customer networks/systems that access, in the example system 100, the document processing agent 110). The document processing agent 110 can be implemented as an independent remote server that serves multiple customers like the customer systems 150a and 150n, and can communicate with such customers via network communications (be it private or public networks, such as the Internet). Communication with customers' units is realized via a communication unit comprising one or more communication interfaces (such as a server interface 120, an admin interface 125, an interactive user query interface 130, and/or expert interface 132, all of which are represented schematically in FIG. 1), which would generally include communication modules (e.g., transceivers for wired network communications and/or for wireless network communication, with such transceivers configured according to various appropriate types of communication protocols). Alternatively, the document processing agent 110 does not need to be located at a remote location, but may be a dedicated node within the customer network. For example, it can be implemented as a process running on one of the customer's one or more processor-based devices, or may be a logical remote node implemented on the same computing device as a logical local node (it is to be noted that the term “remote device” can refer to the customer station, while “local device” can refer to the document processing agent 110, or vice versa). An arrangement where the agent 110 executes out of the customer's network (such as any of the customer networks 150a-n) may improve data security, but may be more expensive to privately run.

Yet in other alternative embodiments, some portions of the system (e.g., the ingestion units configured to perform the pre-processing and vectorization (parametrization) operations on source documents and/or on queries submitted by users) may be located inside the firewall of a customer's network, while storage of ingested documents (and optionally search engines to search ingested content) may be located outside the customer's network's firewall (e.g., on a centralized cloud server(s)). In such alternative embodiments, data sent to the cloud servers (e.g., to perform the search at a centralized location) may already have been processed into encoded (ingested) content (e.g., through vector/transform processing that may have been implemented through coarse transform, e.g., applied to fixed sized input segments, and/or fine-detail transforms applied to smaller portions than the portions processed by the coarse transformer) that is unintelligible to third parties unauthorized to make use of the data, thus adding another measure of privacy and security protection to data that is to be processed using the system 100. In these alternative embodiments, the initial part of the processing of the input query may also be processed inside the customer network's firewall. In addition to performing the transformation (of the source content and/or the query) within a client's firewall, such transformed data may further be encrypted (using symmetric or asymmetric encryption keys) before being transmitted to the document processing agent 110, thus increasing the level of security/privacy realized for communications between a customer's network and the centralized document processing agent (which serves multiple customers).

The example customer network 150a may be a distributed set of stations, potentially with a dedicated secured gateway (protected by a firewall and/or other security measures) that can be controlled (from a station 152) by an administrator. The customer generally has amassed a large volume of electronic documents (including, e.g., technical documentation relevant to the customer's operations, administrative documents such as Human Resource documents, and all other types of written documents in electronic form). Those documents may be arranged in a document library 160 (which may be part of the computing platform of the customer network 150a), and are accessible by various authorized users at user stations 154a-c within the network 150a, and by an administrator (via an administrator station 152). Any number of stations may be deployed in any particular customer network/system. The administrator station 152 can control access to the documents in the library 160 by controlling privileges, and otherwise managing the documents (e.g., access to specific documents within the library 160, management of content to conceal portions that do not comply with privacy requirements, etc.) As will be discussed in greater detail below, in addition to the library 160 (containing documents relating to operation of the entity operating on the network), other sources of data or information may be available from various applications employed by the customer (e.g., an e-mail application, a chat application such as Slack, customer relationship applications such as Salesforce, etc.) to process through the document processing implementations described herein.

The administrator station 152 is configured to communicate with the document processing agent 110 via, for example, an admin interface 125. Among other functions, the administrator can provide the document processing agent 110 with information identifying location(s) of the source documents in the repository (library) 160 maintaining the plurality of source documents, control configuration and operation of the functionality of the document processing agent 110 in relation to the customer network 150a, review data produced by the agent 110 (e.g., override certain answers), provide the document processing agent 110 with training data, etc. Communication between the station 152 and the admin interface 125 can be established based on any communication technology or protocol. To enhance security features, communications between the document processing agent 110 and the administrator station 152 may include authentication and/or encryption data (e.g., using symmetric or non-symmetric encryption keys provided to the document processing agent 110 and the administrator station 152). Using the communication link established between the administrator station 152 and the interfaces 120 and 125, the administrator provides information necessary for the document processing agent 110 to access the document library. For example, the administrator station can send a message providing the document processing agent 110 with a network address for the document library 160 (and/or identity of documents within that library that the agent 110 is to access and process). The administrator station can, in turn, receive an encryption key (e.g., a private symmetric key, or a public key corresponding to a private asymmetric key used by the agent 110) that is to be used to encrypt content of documents that are to be transferred to the agent 110. The communication between the administrator station 152 and the admin interface 125 (or any of the other interfaces, such as interfaces 120 and 130, with which the administrator can communicate) can also be used to establish other configuration settings controlling the exchanges of data and information between the customer network 150a and the document processing agent 110, as will be described in greater detail below.

Once the document processing agent has been provided with the location (e.g., represented as a network address) of the document library 160, and the communication features controlling the transmission of data between the customer network 150a and the agent 110, the agent 110 can begin receiving data transmissions of the documents from the repository (library) 160. The administrator station 152 can control the content sent, and perform some pre-transmission processing on the documents to be sent to the document processing agent 110, including removing sensitive content (e.g., private details), encrypting the content (e.g., using a public key corresponding to a private key at the document processing agent 110), authenticating the data to be transmitted, etc. The document processing agent 110 receives data transmitted from the customer network 150a via the server interface 120, and performs data pre-processing on the received data, including authentication and/or decryption of the data, format conversion (if needed), etc. The server interface 120 then passes the data corresponding to the documents sent from the document library 160 (subject to any pre-processing performed by the interface 120) to a document ingestion engine 126 that processes the received documents to transform (convert) them into a representation that allows the determination and generation of answers to queries provided by a user of the network 150a. Typically, prior to applying the transformation(s), the source document is segmented into portions (e.g., 200-word portions, or any other word-based segment), with the content segmentation performed according to various rules for adjoining content from various parts of the documents into discrete segments. An example of a pre-processing (i.e., pre-transformation) rule is to construct segments using a sliding window of a fixed or variable length that combines one or more headings preceding the content captured by the sliding window, and thus create a contextual association between one or more headings and the content captured by the window. Such a rule ensures that the transformation performed on a segment combines important contextual information with content located remotely (e.g., farther away in the source document) from the segment being processed.

Having segmented the source document, and/or or performed other types of pre-processing, the document ingestion engine 126 is configured to apply one or more types of transformations to the document segments to transform the segments into searchable segments (e.g., question-and-answer searchable segments). One type of transformation that can be applied to the segment is based on transforming the fixed-sized (or substantially fixed-sized) segments, typically comprising multiple words/tokens, into numerical vectors (also referred to as embeddings) in order to implement a fast-search process. Such a search is typically a coarse search, in that it generally returns (in response to a query submitted by a user) a relatively high number of results (hits) because the search is based on matching vectors produced from input data comprising a relatively large number of words (tokens or features), and as a result the resolution achievable from such a transformation is lower than what can be achieved from transforming smaller segments. Thus, results based on coarse vector transformations might not provide as accurate representations of the textual meaning of the transformed content as other transformations applied on smaller segments. On the other hand, as the name suggests, the fast-search can be performed relatively quickly, and thus may be used to winnow the possible candidates of possible answers (to the submitted query) to a size or number that can then be more carefully searched (possibly through a search based on another type of transformation). Another transformation that may be applied by the ingestion engine is one for generating fine-detail vector transformations that are used to more narrowly pin-point locations of answers with some text-segment (e.g., paragraphs) specific answer word sequences. Generally, document segments on which the fine-detail transformations are applied may be at a finer grain (resolution) than fast-search segments (which are generally of a fixed size, e.g., 200 words, and thus cannot typically pinpoint the exact location of an answer, if one exists, within the segment).

More specifically, a fast-search transformation (e.g., implemented through neural networks, filters, etc.) is applied to the segment to yield vectors with values that are based, and therefore are representative of, the content of the document segments. As will be discussed in greater detail below, several approaches may be applied by the document ingestion engine 126 to transform the data according to the fast-search transformation. In one example, the data representative of the content may be transformed into vector representations (e.g., fixed size vector, or variable size vectors). Thus, in such an example, the transform converts textual content into a vector of numerical values, which may or may not be associated with metadata (e.g., text-based metadata, providing additional information that can be used for further processing) or other contextual information. The resultant transformed vector can be representative of possible questions and answers that are associated with the input segment that was transformed. An example of a transformation that yields such vector-value representative of the content of the input (including contextual relationships) is the Bidirectional Encoder Representation from Transformers (BERT)

Under the BERT approach, when a query is received, relevant sequences in the content representation of previously processed source documents can be identified quickly (possibly from a set of objects that may have been earlier identified using, for example fast-search processing) by identifying a part of a document (e.g., a paragraph) that may contain the answer, and identifying the span of words in that part of the document that contains the specific answer. In some examples, under the BERT approach the question and the answer are concatenated (tokenized for example using WordPiece embeddings, with suitable markers separating the question and the answer) and processed together in a self-attention-based network. The output of the network may indicate a score for each possible starting position for the answer and a score for each possible ending position for the answer (with the overall score for a span of the answer being, in some embodiments, the sum of the corresponding start and end positions of the answer). That is, a self-attention method is used where embedded vectors of a paragraph and a query are mixed together through many layers followed by a decision-maker layer and segmenter logic to provide an efficient method to determine if a question is answerable by a paragraph, and if so, determine where exactly the span of the answer lies in the paragraph.

In the BERT-based approach, a network may first be trained on a masked language model task in which a word is omitted from the input, and predicted by the network by an output layer that provides a probability distribution over words of the vocabulary. Having trained the network on the masked language model task, the output layer is removed, and in the case of the question answering task, a layer is added to yield the start, end, and confidence outputs responsive to the query. The network is further trained (e.g., fine-tuned, transfer learning) on supervised training data for the target domain (e.g., using Stanford Question Answering Dataset, or SQUAD). Having trained the network for question answering for the target domain, further training may be used to adapt the network to a new domain. Another training strategy used for BERT is the next-sentence prediction, in which the learning engine is trained to determine which of two input segments (e.g., such segments may be neighboring sentences of a text-source) is the first of the two segments. When training the model, both the masked-language and next-sentence training procedures may be combined by using an optimization procedure that seeks to minimize a combined loss function. Alternatively, or additionally, other training strategies (to achieve context recognition/understanding) may be used separately, or in conjunction with, one of the aforementioned training strategies for BERT.

In example embodiments based on the BERT approach, an implementation, referred to as a Two-Leg BERT approach, may be used in which much of the processing of a query is separated from the processing of parts of a document (e.g., paragraphs) in which answers to the query may be found. Generally, in the two-leg-BERT approach, the neural network architecture has two “legs,” with one leg for processing the query, and one for processing the paragraph, and the outputs of the two legs are sequences of embeddings/encodings of the words of the query and the words of the paragraph. These sequences are passed to a question-answering network. A particular way this approach is used is to precompute the BERT embedding sequences for paragraphs, and complete the question-answering computation when the query is available. Advantageously, because much of the processing of the paragraphs is performed before a query is received, a response to a query may be computed with less delay as compared to using a network in which the query and each paragraph are concatenated in turn and processed together. The paragraphs are generally much longer than the queries (e.g., 200-300 words versus 6-10 words) and therefore the pre-processing is particularly effective. When successive queries are applied against the same paragraph, the overall amount of computation may be reduced because the output of the paragraph leg may be reused for each query. The low latency and reduced total computation can also be advantageous in a server-based solution. As noted, in the implementations described herein, the BERT-based processing of the source documents produces transformed content that is typically stored in a repository (such as the DOM repository 140 of FIG. 1). The underlying documents from which the BERT-based transformed content is generated may be retained as well, and associated with the resultant transformed content (as well as associated with corresponding transformed content obtained via other transforms).

In some embodiments, the BERT-based transformers (e.g., used for the fast, coarse, transformation, and/or for the fine-detail transformation) may be implemented according to encoder-based configuration. For example, a BERT-based transformer structure may include multiple stacked encoder cells, with the input encoder cell receiving and processing the entirety of an input sequence (e.g., a sentence). By processing the entirety of an input sentence, a BERT-based implementation can process and learn contextual relations between individual portions (e.g., words in the input sequence). An encoder layer may be realized with a one or more self-attention heads (e.g., configured to determine relationships between different portions, e.g., words in a sentence, of the input data), followed by a feedforward network. The outputs of different layers in an encoder implementation may be directed to normalization layers to properly configured resultant output for further processing by subsequent layers.

In some embodiments, other language models may be used (in addition to or instead of the BERT-based transform) to transform (content, as part of the pre-processing operations implemented by the pre-processor 110 of FIG. 1, of source documents and/or queries). Examples of such additional language model transforms include:
GPT3 language model—An autoregressive language model that is based on a transformer implementation.
T5 language model—a text-to-text transformer-based framework that predicts output text from input text fed to the model.
BART language model—a denoising autoencoder that uses a standard transformer architecture implemented with a Gaussian Error Linear Unit (GeLU) as its activation function elements, and that is trained by corrupting text with an arbitrary noising function, and uses a learning model to reconstruct the original text.
RAG language model—the Retrieval-Augmented Generation (RAG) language model combines pre-trained parametric and non-parametric memory for language generation.
UniLM language model—a unified language model framework that is pre-trained using three types of language model tasks, namely, unidirectional, bidirectional, and sequence-to-sequence prediction. The unified modeling is achieved by employing a shared transformer network and utilizing specific self-attention masks to control what context the prediction conditions on.
Megatron language model—a transformer framework with a large number of parameters.
ROBERTa language model—a model that is similar to the BERT approach, but with some of BERT's hyper-parameters optimized.
ELECTRA language model—this approach uses a generator unit to replace (and thus corrupt) tokens in the input data with plausible alternatives. A discriminator unit then tries to predict which tokens in the altered (corrupted) input were replaced by the generator unit.
XLNet language model—an autoregressive pretraining framework that uses contexts associated with text to predict neighboring text. The XLNet framework is configured to maximize the expected log likelihood of a sequence with respect to all possible permutations of the factorization order.
Albert language model—this model is similar to the BERT model, but with a smaller parameter size.

Other different language models, implementing different prediction and training schemes, may similarly be used in the implementation of the proposed framework of FIG. 1.

It is to be noted that, in some embodiments, the fast-search vector transformation (transforming a segment into a compact-sized numerical vector) may be applied to a tokenized version of the text (e.g., some transformation, such as transformations achieved through the BERT process, may have already been performed to produce an intermediary (e.g., tokenized) content, to which the fast-search transform is then applied).

The transform modules (BERT-based, or based on any other language transform model) may be implemented through neural networks that have been pre-trained to produce transformed content associated with question-answer pairs. Other transform implementations may be realized using filters and algorithmic transforms. Training of neural network implementations may be achieved with a large training samples of question-answer ground truths that may be publicly available, or may have been internally/privately developed by the customer using the system 100 to manage its document library.

For the fine-detail transformation performed by the document ingestion engine 126, the source data (e.g., text-based portions segmented from a source document according to one or more rules or criteria, with the segmented portions typically being smaller in size than the source segments used for the fast-search transformation) is typically transformed into multiple vectorized (numerical/parametrized) transformed content. The fine-detail transform may also be implemented according to BERT or some other language transform model. The processing by the document ingestion engine 126 can include natural language pre-processing that determines at least some linguistically based information, such as detection and recording of locations of named entities (e.g., person and company names) in the document, expansion of structured data, such as tables, into searchable form of equivalent text, information conversion into knowledge representations (such as a predefined frame structure), extraction of semantic meaning, etc. In some embodiments, the resultant fine-detail transformed data may be combined with the original content that is being transformed, along with derived or provided metadata (although such metadata is not critical, it can facilitate the performance of intelligent searching and question answering for a document). In various examples, the combination of the transformed content and the source segment can be further augmented with automatic questions that may be germane to the source segment, so that these generated questions are combined with the particular segment (or in a particular location in a full document that includes the entirety of the source content and the corresponding transformed content), or with a particular information field. When processing questions from a user, a similarity between the user's question and such automatically generated questions can be used to answer the user's question by returning the information (e.g., a pointer or actual user-understandable content).

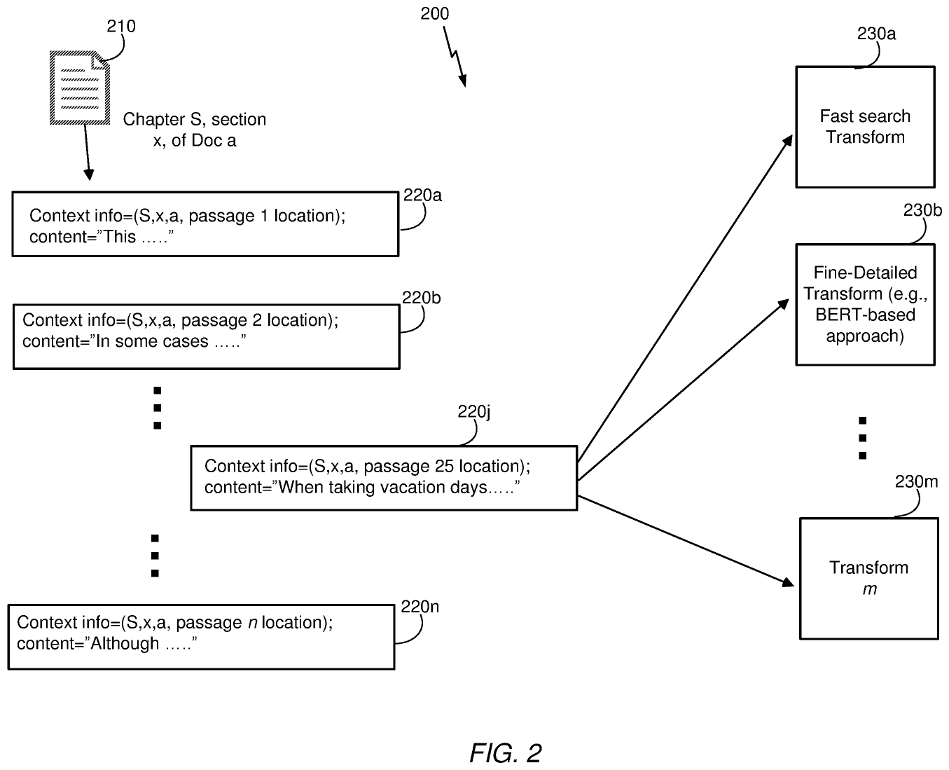

FIG. 2 is a flow diagram 200 illustrating some of the pre-processing and ingestion operations discussed above. A source content 210 (which may be part of a source document) is segmented into segments 220a-n. Each segment has its own individual segmented content (resulting from applying a segmenting window to the source content), that may be combined with contextual information (which may be text information, numerical information, or both) associated with each segment. As can be seen, at least some of the contextual information, namely the document identity (“Doc a”), the Chapter information (Chapter S), and the heading information (section x) is common to the segments illustrated in FIG. 2. This allows the transformations that are subsequently applied to the segment to preserve at least some of the contextual information, and thus preserve some of the relevance of the segment being transformed to the subject matter. To simplify the segmentation process (so as to facilitate more efficient searching and retrieval), the source documents may be segmented to create overlap between the sequential document segments (not including the contextual information that is separately added to each segment). Thus, for example, in situations where a segment is created by a window of some particular size (constant or variable), the window may be shifted from one position to the following position by some pre-determined fraction of the window size (e.g., ¾, which for a 200-word window would be 150 words). As a result of the fractional shifting, transformations (e.g., language model transformations) applied to overlapped segments results in some correlation between the segments, which can preserve relevancy between consecutive segments for subsequent Q-A searching. In some embodiments, heading information (and other contextual information) may be added directly to partitioned segments. Alternatively, headings and contextual information may either be transformed into vectors that are then added to the vectors resulting from transformation operations applied to the content extracted by the sliding window, or may be combined with the content extracted by the window before the transformation is applied to the resultant combined data. By associating neighboring segments with each other (e.g., through fractional shifting of the window over a document to form the segments, and/or through combining metadata, document headings, and so on, to multiple chunks/segments), identification of relevant paragraphs (responsive to submitted queries), for the retrieval and presentation processing for top paragraphs and associated answer snippets, is improved.

Another pre-process that can be applied during segmentation of the source document relates to the handling of table information (i.e., when the original content is arranged in a table or grid). This pre-processing is used to expand structured data arranged in tables (or other types of data structures) into searchable form such as equivalent text. For example, upon identifying a portion of the source document as being a multi-cell table, substitute portions are generated to replace the multi-cell table, with each of the multiple substitute portions including a respective sub-portion content data and contextual information associated with the multi-cell table. Additional examples of pre-processes include a procedure for associating contextual information with one or more portions of the source document based on, for example, a) information provided by a user in response to one or more questions relating to the source document that are presented to the user, and/or b) based on one or more ground truth samples of question-and-answer pairs.

In some examples, contextual information might not be explicitly included with a segment, but instead may need to be discovered, and included with document segments as augmented information (in this case, augmented contextual information). For example, entity discovery (determining identity of relevant entities referenced in the document) can be used to help speed up the search, and to improve searching accuracy.

Consider the following example implementations:
Each search unit (e.g., 200-word windows, paragraphs, documents, etc.) is analyzed with respect to the inherent entities associated with the search unit, and also analyzed with respect to metadata associated with entities for a particular task (e.g., HR, author, organization etc.)
Each search unit is tagged with the appropriate inherent and metadata entities.
During the search, different heuristics can be used which could eliminate many of these search units by identifying them as irrelevant to the query at hand. For example, in one use case, where the user's question is determined with a high degree of confidence to relate to some specific subject matter (e.g., because the user explicit identification of the subject matter, e.g., a question stating “I have a financial question,” or because the subject matter can be inferred, through rules or classification engines, to pertain to the particular subject matter), all documents/document objects for other subject matters (HR, security, etc.) can be eliminated from further consideration, and those documents do not need to be searched in response to the submitted query.
The by-product of such filtering is to speed up, for example, the FM and DM searching. Additionally, potential answer units from irrelevant categories do not create mis-recognition errors, and consequently this helps to improve the accuracy of searches.

Information about a specific entity (or entities) relevant to a user's search can also be used to generate more accurate additional questions (e.g., to determine different ways to paraphrase the input query so that additional possible question-answer pairs can be generated), and also to provide additional context that can be used to search the repository of data (be it DOM objects in transformed form, or user-readable data formatting).

In some embodiments, document pre-processing can be performed as two separate tasks. In one processing task, the source document is properly segmented and organized into small chunks, e.g., paragraphs, with additional augmentations (e.g., the vector sequence that represents the heading of a section can be appended to the vectors of every paragraph in that section). These augmentations are used to improve the retrieval accuracy. In a parallel task, a document is segmented in the most appropriate way for presentation purposes. The two different resultant segmentation outputs need to be associated with each other such that when, during retrieval processing, the top paragraphs and associated answer snippets are identified, but what is presented to the user are the presentation contents (rather than the identified answer snippets) associated with the identified answer snippets. In other words, the system can ingest a particular passage to facilitate searching operations, and separately ingest that particular passage to facilitate presentation operations. In this example, upon identifying the passage as a result of matching a query to the searchable ingested content, the presentation content associated with the identified passage is outputted.

Having segmented a source document into multiple segments, each segment may be provided to one or more content transforms (or transformers) 230a-m that transform the segment (content, and optionally the contextual information, although in some embodiments the contextual information may be preserved without transforming it) into a resultant transformed content that is associated with question(s) and answer(s) related to the original content of the respective segments. In the example of FIG. 2, m transforms are shown, each being applied to any one of the segments (such as the segment 220j). Although the same segment, for example 220j, is shown as being provided to each of the transforms, in some embodiments, different segmentations procedures may be applied to obtain segments of different sizes and configurations as may be required by each of the individual transforms (e.g., the coarse, fast-search BERT-based transform 230a may be configured to be applied to a segment of a first segment size, while the fine-detail BERT-based transform 230b may be configured to be applied to a segment of a second, different size (e.g., strings of several words)). As noted, any language transform model may be used in implementations of the platform 100.

The transform modules may be implemented through neural networks that have been pre-trained to produce transformed content associated with question-answer pairs. Other transform implementations may be realized using filters and algorithmic transforms. Training of neural network implementations may be achieved with a large training samples of question-answer ground truths that may be publicly available, or may have been internally/privately developed by the customer using a document processing system (such as the system 300 of FIG. 3) to manage its document library.

Turning back to FIG. 1, ingested content produced by the document ingestion engine 126 is stored in document object model (DOM) repository 140. The repository 140 is typically implemented on one or more data storage devices (distributed, or available at a single local location) that can be accessible from multiple access/interfacing points between the repository 140 and other modules/units of the document processing agent 110. In the diagram of FIG. 1, the repository 140 is depicted as having two access points, with one access point being a one-directional link between the ingestion engine 126 and the repository 140 (i.e., a link to allow writing content from the engine 126 into the DOM repository 140) and a bi-directional access point connected to a query processing module 136 that provides query data to the DOM repository 140 (in order to search the DOM records stored in the repository) and receives search results that are forwarded to the user (optionally after performing further processing, such as disambiguation processing via an interactive iterative exchange with the user, drilled-down or broadening (backoff) query processing, query-re-write processes, etc.) that submitted the query. In some embodiments, the access point to the repository can be implemented as a single point connected to a module configured to perform the query processing and the document ingestion operations.

The DOM repository 140 is configured to (in conjunction with the document ingestion engine 126 and/or the query processing module 136) store, manage, and search DOM records 142a-n. Content of a DOM record typically depends on the transformation performed by document ingestion engine 126. A DOM record can include data items associated with a particular source document or a source document portion. For example, one DOM record may be a collection of items that includes an original portion of a source document, metadata for that source document portion, contextual information associated with that source document portion, a corresponding coarse vector(s) resulting from a transformation applied to one or more fixed-sized (or substantially fixed-sized) segments of the original portion of the source document (to facilitate a fast-search process), corresponding resultant fine-detail transformed content resulting from a fine-detail transformed (to facilitate a more accurate and refined textual search), etc. Thus, if the transformation resulted in a vector of values representative of the textual content of a segment, that vector is stored in the repository, possibly in association with metadata (added or embedded into the vector), and/or in association with the original content (in situations where the actual original text-content is preserved; in some embodiments, for security or privacy reasons, the source content may be discarded upon its ingestion, or may be available only at the customer's site). Metadata associated with the transformed content may include contextual information associated with the original source content, and document location information that indicates the location or position of source content that resulted in the transformed content within the larger source document. Such document location information can be provided in the form of pointer information pointing to a memory location (or memory offset location) for the source document stored in the customer network, i.e., so that when the pointer information is returned to a requesting user, it can be used to locate the memory location where the relevant content constituting an answer to the user's query can be found.

The transformed content (which may include several transformed content items, resulting from the various transformations applied to segmented content), metadata, and/or source content stored in the repository 140 together may define a unified record structure, in which each of the transformed content, metadata, and/or original source content is a field or a segment of the unified record structure. Individual records, when they correspond to discrete document segments of a larger source document, can be associated with each other (e.g., by arranging them sequentially or through logical or actual links/pointers) to define larger document portions (e.g., chapters for a particular document), or to define the entire original document that was segmented and ingested.

As further shown in FIG. 1, the document processing agent 110 further includes the query unit (also referred to as a query stack) that is configured to receive inputs (data representative of queries from one or more users authorized to submit queries in relation to at least some of the ingested documents arranged in the DOM repository 140), and in turn provide output data returned to the initiating user. The query stack includes the user query interface 130 (which may be similar to, or implemented using the same hardware and software as the server interface 120) in communication with a query processing module 136 (also referred to as a query engine). As will be discussed in greater detail below, the query processing module may include a transform engine to apply to queries submitted by users similar transformation(s) to generate transformed query data that is compatible with the transformed content in the DOM records 142a-n maintained within the DOM repository 140. The transformed query can include coarse numerical vector type transformed data that can be used to search numerical vector transformed content in the repository 140, fine-detail transformed query (that can be used to search similarly formatted fine-detail transformed content in the repository 140), or any other transformed format that may have been used to ingest the source document. In various examples, the interactive interface 130 is configured to not only receive and process query data from the user, and provide query output back to the user, but also to determine (on its own or in combination with other modules of the agent 110) disambiguation information. That disambiguation information may include initially-provided (with the query) disambiguation information to help with the initial searching/matching operations (e.g., prefiltering operations) performed on the searchable content managed by the agent 110 (either in the DOM repository 140 or the cache 135). For example, and as will be discussed below in greater detail, pre-search disambiguation operations may include determining if the query is in-domain (e.g., pertains to local data collections) or out-domain. Disambiguation operations may also be used to determine whether a query is related to a previous query (e.g., in situations where the current query implicitly relies on query terms used in a previous query).

The disambiguation information may also include post-searching disambiguation information dynamically generated that is presented to the user to solicit the user to provide clarifying information to resolve ambiguity present in two or more of the query results. For example, when two answers are associated with the same or similar concept/category of information (be it an entity name, associated contextual information, or some abstract concept derived using natural language processing or a learning machine implementation) but have different concept/category values, intermediary output may be provided to the user (e.g., as a visual disambiguation prompt, or an audio disambiguation prompt) requesting the user to provide clarification information specifying which of the identified concepts is more relevant to the user's query. The disambiguation information returned by the user is then used to select one or more of the initial matches (and may eliminate some other matches), and/or to rank (based on computed relevance determined using the returned input from the user) the initial or remaining matches. Further details regarding disambiguation processing are provided in non-provisional application Ser. No. 18/083,733, entitled “Contextual Clarification and Disambiguation for Question Answering Processes,” the content of which is hereby incorporated by reference in its entirety. In some embodiments, post-searching results may trigger backoff or drill-down operations to identify better quality search results (as will be discussed in greater detail below).

As noted, in examples in which the repository 140 includes multiple types of transformed source content, the search of the repository 140 may be implemented as a multi-pronged search. For example, because coarse numerical vector representation is generally more compact and easier to search (but may not be as accurate as fine-detail transformed representations, whether achieved by a BERT-based transformation or some other transformation), a first prong of a search to determine an answer to a submitted query may be to convert the query data into coarse vector representation, and to use that first transformed query representation to search records in the repository 140 matching (e.g., according to some closeness criterion that may represent the distance, or difference, between the transformed vector query data and the transformed vector ingested content data) the coarse numerical-based transform of the query data. This type of initial searching may be referred to as fast-search. The results of the search may result in the identification of one or more answer candidates (e.g., identify 1000, or any other number, of possible segments that may contain an answer word sequence responsive to the query submitted by the user). The identified first batch of possible results can then be used to perform the second stage of the search by converting the query to a fine-detail transformed query and searching fine-detail transformed content associated with the search results identified in the first stage of the search process. This searching stage may be referred to as the detailed, or fine-grained, search. It is to be noted that, in some embodiments, the fast search may be used to identify the original portions of source content associated with the identified candidates, and those identified portions may then be transformed into fine-detail transform content. In such embodiments, the repository 140 does not need to maintain fine-detail transformed content, but rather the transformation of source content is done based on which portions have been identified by the fast-search as possibly containing an answer to the query. In alternative examples, searching for answer to a query may be performed directly on the entire fine-detail transformed content records without first identifying possible candidate portions of source content through a fast-search of fast-searched transformed content records.

Thus, in some embodiments, the query stack (e.g., the query processing module 136) is configured to transform the query data into transformed query data compatible with the transformed source content (e.g., compatible with one or more of the transformed content records in the DOM repository 140). For example, the fast-search-compatible transformation may be a coarse BERT-based transformation (e.g., using a learning engine implementing the same or similar trained learning model used to produce the searchable transformed content from the source data) that is applied to the entire query data (e.g., a natural language question) to produce a single vector result. The query processing module may, for example, launch a fast-search process in which it identifies one or more candidate portions in the transformed source content (with respective numerical vectors resulting from the coarse transformation) matching, according to a first criterion, the transformed query data. For example, the matching operation may be based on some closeness or similarity criterion corresponding to some computed distance metric between a computed vector transformed query data and various vector transformed content records in the repository 140. The closeness criterion can be based on such measures as a transform-based distance (TBD) scores. As described herein, in some embodiments, the transformed content may include vectors corresponding to possible questions (combined with or separated from other document content) that users may ask, and to which the source content provides a possible answer.

The query processing module 136 may be further configured to determine, from one or more fine-detail transformed content records corresponding to the one or more candidate portions identified based on their coarse transformed vectors, at least one fine-detail transformed content record matching, according to a second criterion (e.g., some other closeness or similarity metric, or the same criterion applied with respect to the coarse transformation data), a fine-detail transformed data of the query data. Alternatively, in embodiments in which a fast-search is not performed, the query processing module 136 may be configured to identify one or more candidate portions in the transformed source content with respective fine-detail transformed content records matching, according to the second criterion, the transformed query data.

In some embodiments, the interface 130 and/or the query processing module may be coupled to a query cache 135 and a question generation unit (which may be part of the cache 135 or of the query processing module 136, or may be a separate unit). The query cache 135 stores, among other things, answers/contents corresponding to frequently asked questions. Such answers/contents may include content previously retrieved and/or distilled from the DOM documents (and/or from their corresponding raw source content) in response to previously submitted queries. The content available on the cache storage may also include original content (i.e., content not retrieved or distilled automatically from the content repository) curated by a subject matter expert. Counters associated with such cached answers can track the frequency at which specific questions and answers have been submitted and/or retrieved. The cache 135 can also be configured to discard cached content that has not been requested within some reference (threshold) time interval. As noted, content in the answer cache may also have been stored by a subject matter expert, or by the administrator (e.g., operating from a station, such as the station 152 via the admin interface 125) in anticipation of some likely questions that users of the customer system (network) 150a were expected to submit, or to override content that may have been retrieved from the DOM repository 140 (e.g., content that, based on subsequent feedback from users, was determined to be inaccurate or unresponsive to the query submitted). Thus, in some embodiments, the query stack is configured to determine whether received query data matches (semantically, as may be determined by a machine learning semantic matching model, or is some other sense) one of pre-determined questions (which may be stored in the answer cache), and to generate the output data based on one or more answer data records (possibly stored within the answer cache) in response to determining that the received query data matches one of the pre-determined questions. In some embodiments, the matching of query data to the past questions and associated answers stored in cache is performed by computing a score that is based on the combination of the questions and their answers, and ranking the computed scores to identify one or more likely matching candidates.

The query processing module may also include a question generation engine that can determine (e.g., based on a trained learning engine and/or using a repository of question data) follow-up or related questions to one or more questions submitted through the query data. Follow-up questions can be generated by paraphrasing the query submitted, e.g., transforming and/or normalizing the submitting query to modify the question submitted using, for example, a trained learning engine. In some embodiments, answer data determined for the submitted query (e.g., based on content retrieved from the DOM repository 140 via the query processing module 136) may be processed (by a separate module) to formulate further questions from the answer. Such derived questions can then be re-submitted to the query processing module to retrieve follow-up answers. This process can be iteratively repeated up to a pre-determined number of times. In some situations, the content stored in the DOM repository 140 may associate multiple questions (represented in whichever transformation format(s) that was applied during the document ingestion stage or may be presented in a regular linguistic format) with each processed segment of the source document. As noted, generation of transformed content may include, for each processed segment, data representative of questions associated with the processed segment, metadata, and content that may be provided in transformed format and/or the original source content. Thus, upon submission of a query (generally in transformed format computed, for example, according to a coarse-BERT or a fine-BERT type transformation), at least one DOM record/element will be identified. That search result may possibly be associated with multiple questions, including the question that may have resulted in a match between the identified resulted and the submitted query. One or more of the additional questions (i.e., other than the question that was matched to the query) may be used as a separate query to re-submit for searching to identify additional content that may be germane to the original query submitted by the user.

As further shown in FIG. 1, the determination of an answer to a query can be initiated by a user submitting a query 172 via a link 170 established between a station 154a and the interface 130 (as noted with respect to the links established to transfer source documents for ingestion, the links can be based on any type of communication technology or protocol, including wired and wireless communication protocols). The query 172 may be an actual unprocessed question submitted by the user, or may be partially or fully transformed (e.g., for privacy and security reasons). For example, the station 154a may apply a transformation commensurate with the transformation applied by the ingestion engine 126 (in which case, performing a similar transformation at the query stack may become unnecessary). Alternatively or additionally, authentication and encryption processing may be performed on the query 172. The query (question data) 172 is transmitted to the document processing agent 110, and is received at the user query interface 130. Upon receipt of the query, a determination may be made as to whether appropriate answers are available in the cache 135 of pre-determined answers. If there is a pre-determined question-and-answer (e.g., the query data matches semantically, or otherwise, one or more pre-determined questions), one or more of the pre-determined answers is used to generate the output data (illustrated as output data 174) that is returned to the user via the link 170 (or through some other link).

Generally, the query data is transformed (if it was not already transformed at the station 154a) by the query stack into transformed query data. The transformed data may provide the query in one or more transform formats that are compatible with the formatting of the transformed source content stored in the DOM repository 140. In some embodiments, the query data may also be used to generate one or more additional questions (e.g., follow-up questions, questions related to the original query submitted by the user, questions with re-written terms that are semantically equivalent to one or more terms from a submitted query, etc.) In situations where an answer to the query is available from an answer cache, that answer itself may be used as a basis for generating further one or more questions that may be related to the cached answer(s). The query or the transformed query is used to search, via the query processing module 136, the DOM repository 140. As noted, the searching may be performed as a multi-pronged process according to multiple transformation formats used to store data in the DOM repository 140.

The output generated in response to a submitted query generally may include a pointer to the source content available at the customer network 150a. Because the data stored in the repository 140 is ingested based on source documents maintained at a document library available at the customer network, to which the user submitting the query has access, and because the source document might not have been stored in their original form at the document processing agent 110 (e.g., for security reasons, in order to protect sensitive data from being compromised), the output that is returned to the user does not require that actual answer data be sent back to the user. Instead, the pointer returned as the output of the query can identify the address or location of the answer with the appropriate document available to the user at the user's network 150. For example, in the illustrated example of FIG. 1, the output data is shown as a pointer to the specific location of the answer in the document 162a (stored in the library 160 along with documents 162b-d). Such a pointer may thus include data representing the document 162a, e.g., a network address or a memory location where the start of the document is located, and a specific location of the portion(s) of the document that represents the answer to the question asked by the user at the station 154a (e.g., a relative offset from the beginning of the starting location of the document 162a, or an actual address or memory location where the starting point of the identified portion(s) is located). The pointer data provided in the output data may have been included in a metadata field of a DOM record that included transformed content data determined (e.g., by the query processing module 136) to match (according to one or more applied matching criteria) the query submitted by the user. In some embodiments, the output data may include, in addition to or instead of the pointer data, at least part of the source content corresponding to the at least one portion of the transformed content and/or a summary of the source content corresponding to the at least one portion of the transformed content.

### 3 Backoff and Drilldown Searching

A first approach, which may be used to modify the architecture described in the previous section relates to backoff and drilldown approaches to searching.

The searching/information-retrieval framework described herein includes implementations directed to finding improved answers to queries by searching for broadened concepts (backing-off searches), or for narrower concepts (drilling-down searches) in a hierarchical arrangement of concepts. The drill down process can implement a question-based retrieval of options (e.g., visual display of answers directed to ontological concepts at a level lower than the concept captured/associated with the initial query), and the backoff process may also be based on an ontology, to submits progressively broader questions until a reasonable level of relevant (matching) answers are obtained at a broader level of generality.

The implementations include determining by a searching system (e.g., a Question-and-Answer system such as the system 100 depicted in FIG. 1) search results for a first query that includes one or more query terms associated with a first concept, modifying the query, based on the search results (e.g., based on whether the initial query provided good answer results as may be determined based on how many answers/responses meet a pre-determined matching criterion, based on feedback from a user, etc.), to include modified query terms associated with one or more concepts hierarchically related (e.g., as may be defined in an ontology of concepts or entities) to the first concept, and determining at a subsequent time instance one or more subsequent search results for the modified query comprising the one or more modified query terms.

For example, the backoff functionality of the proposed network is configured so that when a query includes an entity (be it a person, company, object, or otherwise) that is too specific, (e.g., answer is about a “type” rather than an “instance”), the system is able to walk up an ontology of products to launch a more generic search that finds more appropriate answer(s). Thus, a backoff process (in which the query may be too specific, may be yielding an insufficient number of responses, or may be yielding responses failing to satisfy a matching criterion), modifying the query may include generating replacement queries using revised query terms that cause the searching system to search content directed to a broader concept that is at a parental hierarchical level (e.g., in a predefined ontology) in relation to the first concept. In a drill-down process, modifying the query may include using, in the query, search terms to cause the searching system to search for content directed to one or more child concepts that are at a child hierarchical level in relation to the first concept. Thus, depending on an analysis of the query submitted, or on resultant search results for the submitted query, one or more concepts (from an ontology or dictionary of concepts) associated with the submitted query, or with the responses for that query, are identified.

In various examples, the identification of an ontological concept(s) can be accomplished, for example, using a machine learning engine for concept identification. Such an ML engine nay be a separate/independent system from the machine learning engine performing the query on the Q-A system 100 (through, for example, a machine learning system implementing a vector transformation mapping a natural language query into an embedding/vector space). The resultant modified query terms can then be processed by the query processing system 136 of FIG. 1 (e.g., transforming the modified query into a vector representation in an embedding space implemented according to one or more vector transformation language framework such as BERT). An ontology of concepts can be as specific or as coarse as desired, depending on the desired implementation and availability of training data and ontologies.

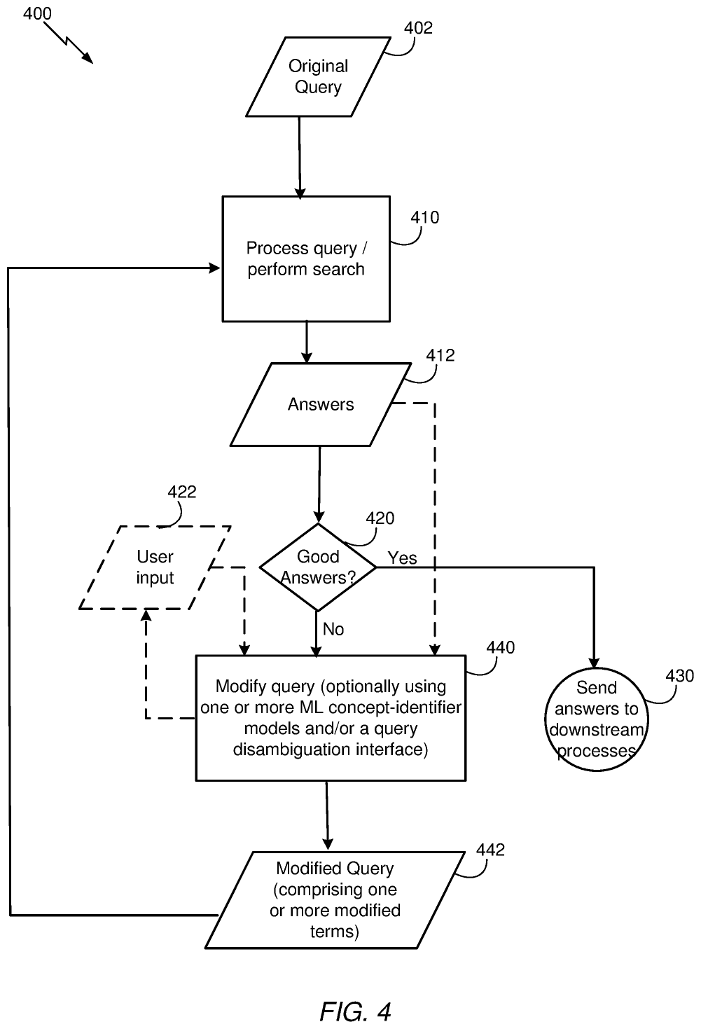

Entities (i.e., concepts) are typically organized in some hierarchical arrangement that implicitly or explicitly define some relationships between the concepts. For example, and with reference to FIG. 3 showing a diagram 300 depicting an example hierarchical arrangement of a product (in this case, laptops). A particular type of product (e.g., laptop) may be associated with different families (Dell Inspiron vs. Dell Precision), and each such family may be associated with multiple series (3000, 5000, and 7000 for the Inspiron family). Each such series may, in turn, have multiple different models (Dell Inspiron 3558). Different types of information can be associated with different levels of the hierarchy. In the example of FIG. 3, the concept of how to download MS Office might be associated at the laptop level (e.g., the ontology may include troubleshooting concepts that are associated with each hierarchical level of the ontology), the concept of how to change the battery may be associated with the model level of the hierarchy, while troubleshooting some particular problem might be associated with the series level entries of the ontology. Users do not necessarily know which level they should be asking about, so if a user submits a query asking how to download MS Office on the Inspiron 3780, the mention of the laptop can cause the search engine to prefer answers that specifically mention this model and miss the general procedure. As a result, the identified query answers for a query for a software downloading procedure that includes a specific model may results in a relatively small number of answers and/or answers with matching scores that are below a required threshold (or alternatively, the searching operations may yield an insufficient number of answers that have respective matching scores exceeding the required threshold). Since, for this example, the downloading procedure of the MS Office suite is generally discusses in relation to the laptops, rather than specific families, series, or models, the drilldown/backoff framework is configured to determine that the query needs to be backed-off so that a modified query is produced that removes concepts at a hierarchical level 340 in the hierarchical diagram 300 of FIG. 3. Instead, the modified query may include concepts at a hierarchical level 310 (i.e., at a laptop brand level), possibly without reciting lower level concepts (such as the model hierarchical level 340, the series level 330, or the family level 320). The query modifier (more particularly discussed below in relation FIG. 4) is thus configured, in a backoff implementation, to remove concepts, or alternatively to replace concepts to include more generic (at a higher parental level) concepts than what the current query included.

As noted, the proposed framework also implements drill down functionality in which, when a query is asked at a high level, such as how do change the battery on an Inspiron laptop, the system should be able to query the user (or indirectly eliciting feedback from the user, as will be discussed in greater detail below), walking down the hierarchy to where the information is associated with the correct model. The system may alternatively get user specific information from the dialogue context or from a user profile. The proposed drilldown/backoff framework described herein is configured to determine whether to back off or drill down, based, for example, on the lack of a good answer for the original query.

FIG. 3 further illustrates a drill down query modification in which, upon a determination that the query is not sufficiently specific, or is missing some query information (concepts), the drilldown framework determines (possibly using feedback from the user, such as disambiguation feedback) more detailed concepts that are needed to produce query answers satisfying matching criteria. For example, consider a query asking “how do I remove the battery in my 3000 Inspiron.” The backoff/drilldown framework is configured to determine (e.g., based on a machine learning implementation trained to determine the specific details that are usually associated with different concepts in an ontology) that battery removal (the concept identified from the query) corresponds to information typically given with respect to specific laptop model, and to further determine that the specific model number is missing from the query. The framework can then activate a disambiguation process that requests further specificity from the user, or alternatively may infer the missing information (e.g., the model number) based on contextual information (e.g., based on previously asked queries that included the model number, based on the type of laptop through which the query was submitted, etc.) In the example of FIG. 3, the framework executes an interactive disambiguation dialogue that asks the user to specify the model for which laptop's battery is to be removed (as illustrated by arrow 304).

The backoff/drill-down implementations may be adapted to try one or both of the backoff and drilldown operations (in parallel or sequentially) and return the best answer. In certain examples, a determination of whether to perform a query backoff operation or a drill-down operation may be based on a categorization of the query/intent that is associated with information (e.g., contextual information) of whether a drill down or back off is required. For instance, and referencing again the example of FIG. 3, if a user submits a query specifying a laptop brand but seeking information about a concept associated with one of several series of the laptop family, the drilldown/backoff platform may be configured to automatically modify the search to include a drilldown concept specifying the laptop series that the framework determines is associated with the submitting user (e.g., based on identifying contextual information such as a MAC address included with the remote communication message that included the user's query, based on laptop series information that may have been provided in relation to earlier queries submitted by the user or some related group of users, etc.)

As noted, determining which entities (concepts) in the query to back-off or drill-down to can be performed by using an ontology (if one is available). In situations where a query identifies multiple entities items (e.g., “laptop” and “battery” and “Inspiron”), and there is consequently ambiguity as to whether improved answer quality can be achieved based on a drilling-down process (i.e., generating a modified query using more specific concepts selected according to a decision on whether to drill-down or backoff) in which queries can be modified by replacing and/or dropping each entity, in sequence or in parallel, and evaluating the quality of the returned search results. The quality of the returned results (e.g., computed according to one or more matching criteria) can be used to determine whether to continue the process (and possibly the direction of the further searches) or halt/terminate the process.

The proposed framework deals with the idea that when a user asks a question, the user does not know at what level is this question this question be answered. For example, the user has a particular piece of equipment, and is asking a question about downloading Microsoft Office. From the point of view of the question answering system, mentioning that laptop becomes a red herring in the question. In other cases, the user might indicate “I've got this Inspiron laptop,” but the information sought may actually depend on the specific model. The Q-A system is configured to implement a combination of processes of backing off or drilling down procedures. When the Q-A system backs off, and there is hierarchy structure of concepts, the system can determine where to proceed, and so it can walk up the hierarchy. When the system drills down, the system may not know how to proceed, and therefore might need to prompt the user. That is, in order to answer a question regarding entities mentioned, the person might have mentioned the wrong spot in an ontology, and the system needs to decide in what direction to move (or it may try both up and down directions) if the system does not have a great answers for the question. Thus, the system can back up (modify the query to cause a broader search), or ask the user for feedback in order to drill down. Backing up might require determining a direction in a network structure rather than a tree structure. In various examples the system can use an ontology to know how to get the right level (for an entity ontology) in order to be able to answer a question that yields a satisfactory answer result (e.g., meeting a scoring threshold).

The proposed backoff solution described herein may also address the issue arising when people who author content generally have some objective, and write the content based on some sort of ontological understanding that they have, which could be very different from the understanding others have. Many times, to the specific question being asked does not have an answer in the authored content because the authors already know, for example, that the battery life of all Inspiron computers is five years. Therefore, the authors may not see the benefit of writing in a document, for every model, that the battery life of Inspiron 2, 3, 5, or 6 is five years. The authors may, somewhere in a higher level document or description, capture the information that the battery life of Inspiron laptops is five years. Suppose that a user submits a query of “I want to know the battery life of Inspiron Model 26853.” What may happen is that there is no content (and thus no answer) anywhere in which the model number, and all of the other specifics of the query, are found in close proximity to each other (based on some concept proximity criterion). Rather, there may be a passage in one of the documents in the content repository that mentions in one of the searchable document objects that the battery life of Inspiron laptops is five years, while another unrelated passage (of the same or different document) may discuss one or more specific models of the Inspiron laptop, but in relation to some unrelated issue. Under such circumstances, the Q-A system may not yield “good” answers (meeting some quality criterion), and may thus cause the backing-off process to be executed. Under the backing-off feature, as described herein, the Q-A system backs up from the model to its type/series. If that is not sufficient to determine a good answer, the Q-A can proceed further up the hierarchy. If there are two or three hierarchal levels, the system can continue going up (i.e., backing up) until an answer is reached (possibly at the root level). As noted, when the query includes extra information, the extra information, e.g., the model number, could, in a statistical matching, find a completely different context that could create a lot of errors in what the system brings back. If the system does not find the right answer, it latches on to something else that contextually relates to, for example, “Model 2538,” and therefore it makes an error. By effectively modifying the query, according to a backing-off or drilling down procedure, to remove or suppress one or more of the pieces of information available in the query, a relevant answer can be found.

When a question comes in and a search is executed for it, the question is searched potentially for the entire Q-A system. If it does not come back with a very strong answer, it is an indication that the system should trigger backoff. The backoff can be performed in two ways. First, the backoff can always be triggered. When there is a model number, the backoff can be triggered, for example, with its type and with its parents, grandparents, etc. The second way is based on whether there is a good result, and if there is not the backoff process can be performed. Both approaches have pros and cons, but the backup process generally provides value.

To further illustrate the functionality of the query modification approach (be it to perform a query backoff operation, or a query drilldown operation), consider the flow diagram 400 of FIG. 4. Assume that a user submits a query 402 such as the one discussed in relation to FIG. 3, namely, “how do I download MS word on my Inspiron 3780?” (of course, the query can be about any subject matter for which searchable content is stored on the data repository, such as the DOM repository 140, or is otherwise accessible through the document processing agent, such as the agent 110 of FIG. 1). The query 402 is provided to the process query block 410, which may be implemented using, for example, the interactive user query interface (with which the user interacts and can provide the query and additional information), and the query processor 136 (processing of the query may also involve access to a Q-A cache, such as the cache 135). In an example, the process query box 410 performs one or more machine learning vector transformation operation to transform the query into, for example, an embedding space compatible with the transformed content stored in the repository to be searched. For example, the process query box 410 may be configured to first perform a coarse vector transformation, based on a BERT model or one of the other models discussed herein, followed by a fine-detailed transform to search the coarse-detail search results. In various embodiments, other pre-search processing may be performed instead of or in addition to applying transform-based model like BERT. For example, the query may be processed using natural language processing models to obtain a semantic meaning from the submitted query.

The process query box 410 next searches the content repository (e.g., the repository 140 of FIG. 1) to identify matches between the transformed query 402 and the content arranged in the repository, and returns answers 412, which may include answers presented in semantic form, a particular visual form, and/or the vector-transformed form. The identified answers may be those portions of the content being searched that satisfy a minimal matching criterion (for example, the identified answers are those with a relevance score exceeding some pre-determined threshold). Relevance/matching scores may be computed, for example, according to a distance measurements between semantic content of an answer and a corresponding question, according to a predicted output of a trained machine learning engine that assesses relevance of a question and a candidate answer, according to a computed Transform-Based-Distance (TBD) score between a question and an answer, according to a posterior probability equivalent of the TBD, or according to any other relevance derivation process. A particular question and answer pair with a high relevance score indicates a likelihood of a match between the query submitted and the content searched.

Having identified an initial batch of possible relevant answers, a determination is then made (at decision block 420) of whether the answers 412 represent a successful search that yielded good answers (according to some pre-determined criterion). For example, the identified answers may be deemed to be include good answers if at least a minimum number of identified answers exceeds a “highly-relevant” threshold (typically different from the relevance threshold used by the process-query box 410 to identify the answers 412). In another example, the answers are deemed to be good answers if the number of relevant answers (e.g., the number of returned answers in 412) exceeds a response-number threshold, or if there is at least a subset of answers (from the answers 412) whose computed relevance scores exceeds some threshold that is higher than the threshold used to identify the answers from the repository, but possibly lower than the “highly-relevant” threshold value. If a determination is made that there is a sufficient number of good answers, no further searching is required, and the returned answers responsive to the query are provided to downstream processing (which may include operations to output the answers to a user, generate formatted reports, store and/or arrange returned data in a result repository, etc.)

If, on the other hand, it is determined that the query processed did not return a sufficient number of good answers (or a sufficient number of quality answers), operations to modify the query based on the drilldown or backoff approaches described herein are performed. As noted, the modification of a query can be performed using an ontology realized, for example, using a machine learning concept-identifying model that was trained to output labels corresponding to concepts of one or more ontologies (a separate machine learning model can be used to first identify, based on the text of the query, the ontology(ies) that needs to be used).

A machine learning model (implemented based on a neural network architecture, or any other machine learning architecture) can receive as input the preceding query, the query results (e.g., the set of answers and/or relevance scores and any other information generated as a result of the preceding query), and interactive input from the user (e.g., in the event disambiguation feedback from the user is needed). The modify query block 440 may include several separate machine learning models that are executed concomitantly to produce predicted output concurrently. For example, the query may pertain to several concepts that would each need to be identified in order to replace (e.g., remove from, or add to) the query terms with appropriate terms to produce an improved answer set. In another example, a first upstream machine learning model may be configured to generate a label that is representative of a concept (according to an ontology) that the query pertains to. That generated label can be fed into one or more downstream models to generate output labels that are representative of concepts that are at a higher or lower hierarchy to the concept associated with the label generated by the upstream machine learning model.

In an example, the concept identifying machine learning models may identify the central subject matter of the query (e.g., in the example query 304 of FIG. 3, the central concept of “how do I download MS word on my Inspiron 3780?” may be determined to be MS Word installation), as well as secondary concepts (for example, in a laptop-based ontology, the query 304 may also results in output comprising the laptop family, series, and model associated with the query). The identified concepts can be analyzed by a query analysis process (e.g., a rules-based process) to determine whether to replace, remove, or add one or more of the identified concepts/terms in the query that is being examined in the modify query block 440. For example, and with reference again to the query 304 of FIG. 3, the query analysis can include rules indicating that for the central concept of MS Word installation, only the brand of the laptop needs to be known, and therefore additional information such as the specific brand model, or model series are not important and may result in query answers with low relevance scores (because the query processor is searching for answers that include matches to concepts/terms that are not germane to the query). Based on the analysis of the identified concepts (and optionally the actual query), and their hierarchical relationship (e.g., in the laptop ontology, the family and model number are child concepts of the laptop brand), the modify query block 440 generates a modified query (depicted in FIG. 4 as modified query 442) in which one or more query terms are replaced, removed, or added. In the example of the query 304, the modified query may remove the model number “3780” from the query to generate a modified query of “how do I download MS word on my Inspiron?” Alternatively, the modify query block may replace “Inspiron 3780” with “Dell laptop.” In various examples, the query modification processing may be such that the modification is performed gradually and/or iteratively in a way that tries to avoid significant changes from one iteration to another.

As noted, unsatisfactory answers may be produced from a query that is too general. For example, the lack of specificity may produce too many matches for the general concept corresponding to the query. In such situations, the searching processes described herein (e.g., based on a modified queries approach) can also proceed in the opposite direction, i.e., drill-down, in which concepts from lower child levels of conceptual hierarchies are determined and used to obtain refined search results. One approach, when implementing more specific searches, is for a user, using conversational system to interact through a dialogue flow. For example, a user, having a problem with Nvidia-based device, may say (through the dialogue interface), for example, “ConnectX.” The Q-A system may execute this dialogue entry, but the system may not return specific content to the query. The system and/or user may nevertheless recognize that “ConnectX” has two child concepts at a concept level immediately below the broad concept of “ConnectX,” and may prompt the user to indicate which of those child concepts it may need. Even at the next level, the system may not find a perfect match. So the user interacting with the Q-A system may cause another search to be executed at a lower level (e.g., providing to the system additional disambiguation information). This process is basically a natural language interaction.

In another approach, rather than authoring a dialogue flow, the different child concepts may be presented as questions with answers. That is, if somebody comes and says that, “I want documentation for ConnectX,” there may already be an ontology from which it can be understood that when a user submits this type of a query, the system matches the broad query to possible answers (which may not include any good matches) that correspond to searches with query terms for concepts at the next lower level to the concept corresponding to the “ConnectX” entity. Thus, in this approach the system does not really articulate a dialogue flow, but instead it creates a large number of question-answer pairs (referred to as augmented FAQs) that are associated with concepts at the hierarchical level below the concept that corresponds to the search just complete. This mechanism is referred to as visual QA. Because the answers for the next lower level are displayed, the user is given the option to select answers resulting from a deterministic process. Every time one of the displayed answers is clicked/selected, another augmented FAQ (corresponding to queries covering concepts at the next child level) gets triggered. Through this iterative process the user may finally land at the list that includes the desired answer the user is looking for (but did not specifically articulate in the initial query).

The value of the visual QA approach is that it provides the mix initiative or at least change of mind. If the user realizes (based on the retrieved answers at an intermediate child level) that that was not what the user was looking for, the user can scroll back up on the screen and click on a different button, and repeat the process. This approach thus implements a visual IVR, in which branching options are given through visual FAQs that are possible (depending on the concept level) at any given point in time.

The proposed approach can augment the question-answering system so that not only does the question elicit answers as they exist, but also bakes in responses that are basically follow-up prompts. For example, in response to the query “How do I install something in Windows?,” the system provides answers that implicitly also prompt the user for disambiguation information. The system can determine whether to give the person a follow-up prompt-like response, as opposed to a terminal answer. In the visual feedback for a QA system, the prompts (for disambiguation information from the user) include answers that make it easier and faster for the user to guide the searching process. Here, the answers are all cooked in the form of a bunch of FAQs. Everything has been prepared as a bunch of FAQs, which are the augmented FAQs, versus dynamically deciding that a question needs some disambiguation information before it can provide an actual answer.

As another example, a user may submit a query that says, “I'm interested in the Dell Inspiron computers that are below 1,200.” The Q-A system goes ahead and executes the search. Then, a number of answers (e.g., seven, eight, or any other number of answers) may be found for model satisfying the query, and the system may then visually present those answers. Thus, under this approach the flow tree was not implemented in a traditional way. Rather, queries are decodified as a next-set of dynamic questions (i.e., using the question-answering mechanism to elicit the feedback in order to drill down). If a user clicks on a button, the button automatically creates the next question. Consider the query “I need help with ConnectX-3.” Here the query may lead to an FAQ with answers that are displayed to the user (e.g., showing answers corresponding to three different ConnectX-3 items, including “ConnectX-3 EN”). When the user clicks on the choice for Connect X-3 EN of the choices, the chosen answer maps itself to another question, which may be “I really need help with Connects 3EN.” Then, for that query there may be several answers that produce augmented FAQs. Instead of creating a dialogue tree, the system dynamically implements a flow process that includes the presentation of selectable answers that can be drilled down to provide more specific answers.

Further description of embodiments of the drilldown approach is provided with reference again to the illustrated scenario of FIG. 3 and the flow diagram of FIG. 4. A user may submit a question such as “how do I remove a battery in a Dell laptop?” If the battery removal operations differ for different Dell laptop and/or for different series and models, the information retrieval system may identify a large number of potential matches for the query. In order to provide the user with a more manageable or meaningful set of answers, the proposed framework is configured to recognize, e.g., based on the analysis of the answers performed at 420, that the query is too generic. For instance, the framework may be implemented using a set of rules that use a set of thresholds to determine if the set of resultant answers do or do not include sufficiently close enough matches. Thus, for example, if none of the answers is associated with a relevance/matching score exceeding some pre-determined “sufficiently matching” threshold, but there is at least a subset of answers with associated relevance/matching scores exceeding another threshold (lower than the “sufficiently matching” threshold), the framework may deem the resultant answers to have resulted from an overly generalized query, and may, consequently, cause a drilldown-based query modification process (implemented by the block 440) that requires, in certain examples, input from the user (implemented at the block 422).

Drilldown processing may be implemented in one of several ways. As noted, in a first example implementation, the framework may be configured to identify one or more hierarchical concepts (e.g., using an ontology defined through a machine learning system) and to select from the answers provided at 412 answers that correspond to concepts at an immediate lower ontological hierarchical level to the ontological level corresponding to the recognized concepts of the submitted query. For example, if the query submitted was “how do I remove a battery in a Dell laptop?,” the proposed framework may select the best matching answers that correspond the hierarchical concepts from the family hierarchical level 320 of FIG. 3. This selection process may also exclude answers that contain concepts pertaining to lower hierarchical levels. The initial selected subset of answers (with information best matching the hierarchical level immediately below the level corresponding to the ontological concept identified for the submitted query) may be presented in the form of the answers to the query, or, as discussed above, in the form of Q-A pairs (e.g., pre-determined Q-A pairs generated during document ingestions). The user may then select (as part of the operations of the user input block 422) one of the presented outputs, which may cause a modification of the query to include the ontological concept corresponding to the answer selected by the user. Alternatively, if the output is presented as candidate Q-A pairs, selection of one of the presented choices will cause modification of the query to a modified query that may include, or is based on, the pre-determined question of the selected Q-A pair. The resultant modified query 442 can then be re-processed (at the block 410) in a manner similar to the backoff processing described herein.

In various examples, the selection of an answer from the subset of answers best matching the immediate lower hierarchical concept level identified for the query can cause the presentation of a further subset of best-matching answers (from the answers 412) that contain concepts corresponding to the next lower hierarchical concept level. For example, if the user selected an answer (responsive to the query “how do I remove a battery in a Dell laptop?”) that discusses battery removal for the Inspiron, a subset of answers related to battery removal for the Inspiron 3000, 5000, 7000 may be presented in a follow-up answer output iteration.

Another example implementation of a drilldown process may be based on an interactive disambiguation procedure similar to the one described in U.S. Ser. No. 18/083,733, entitled “Contextual Clarification and Disambiguation for Question Answering Processes.” Briefly, during document ingestion of source content, the dimensions of ambiguity in the source content are derived, e.g., using a trained machine learning system. Such dimensions can be formulated as a set of category/value tuples (a derived category for a content segment may be different from concepts associated with that content segment, and may thus be determined using a different machine learning model than that used to identify concepts). Two passages in the content that are identified as possible answers to a query are ambiguous along a particular dimension if they have dimension values (e.g., metadata or some associated generated data record) corresponding to the same category but with different values. Alternatively, deriving the dimensions of ambiguity can be performed during search time only for matching answers. In such examples, when processing a query (e.g., performed at the block 410) the answers may be returned along with a set of categories and respective values representing the dimensions of ambiguities.

The identification of multiple valid result records may be indicative that there is ambiguity in the results of the search, possibly because the search was not specific enough, yielding, consequently, multiple legitimate answers. Determination of ambiguity in the identified matches is performed by a query ambiguity detector (which may be implemented as part of the operations constituting the block 440) that determines whether two or more answers that are associated with a particular ambiguity dimension category have different respective values for at least some of the multiple matches. It is to be noted that in various examples, the existence of multiple answers may not necessarily be deemed to create ambiguity. For example, the ambiguity detection framework may be configured to detect an ambiguity condition only if the number of matches exceeds a certain answer threshold value. On the other hand, if the search returns fewer matches than the answer threshold number, the user may be allowed to consider all the identified matches.

In some embodiments, multiple ambiguity dimension categories with conflicting values may be identified for a particular set of matches, and the user may then be prompted to provide disambiguation/clarification information for all (or some) of the identified concepts. Obtaining disambiguation information (e.g., when available contextual information did not sufficiently eliminate returned matches to a manageable level) is performed by dynamically interacting with the user to solicit from the user needed disambiguation information to aid selecting one or more of the answers from the initial or remaining answers. An interaction process (visual or audible) may be executed to determine, e.g., for one or more of the ambiguous categories associated with the current set of answer matches, which value (be it an entity value, or some abstraction of the information included in the answers) matches what the user is looking for. This can be achieved by, for example:
a) Presenting to the user with the set of values and a general prompt, “please select from the following:” (“Visual form dialog”);
b) Using natural language generation techniques to create an appropriate prompt (e.g., based on identified concepts associated with the possible answers that are creating the ambiguity). For example, to disambiguate between two answers that are associated with the same (or substantially similar) categories, but have different values, the interaction process may generate a question to the user asking the user to provide more specificity regarding the ambiguous concept. For an example query “how do I install a browser?” that results in two possible answer matches associated with browser installation concept (one for a Mac™-based computing system, and one for a Windows™-based system) the interactive message to the user may ask the user “which computing system [or operating system] do you need to install a browser for?” Alternatively, the message to the user may list the different computing systems, and ask the user to specify which one the user needs information for. In embodiments in which there are multiple categories that are identified in the set of matches, the disambiguation process may seek to obtain disambiguation information for the most common concept determined for the multiple matches. Alternatively, other criteria, or policies, for identifying the likely concept or category to disambiguate may be used, e.g., identifying a concept, entity type, or category that can most prominently distinguish (i.e., have the greatest disambiguation impact, or highest information gain, to eliminate the most answers) between the various answers.
c) Selecting from a list of prompts that have been written in advance, for example for a chatbot in a relevant domain; and
d) Continue interacting with the user until at least some of ambiguity is resolved (e.g., some threshold number of answers is reached, or, in some examples, all ambiguity is resolved).

Thus, the dynamic interactive process (which may implement a visual interface, an audio interface, etc.) is configured to generate output data to prompt a user to provide disambiguation/clarification information, and select at least one of the multiple matches based, at least in part, on the clarification information provided by the user in response to the generated prompt. The interactive process configured to generate the output data to prompt the user to provide the clarification information is configured to automatically generate an output prompt based on one or more of, for example, generating a list with selectable items corresponding to different values for one or more context categories, applying natural language processing to the identified multiple matches to generate a prompt with a list of selectable items from which the user is to select one or more of the selectable items, and/or selecting from a set of pre-determined prompts one or more items.

The disambiguation process may be repeated until some or all of the ambiguity is resolved by iteratively generating refined output data, based on non-excluded matches from the set of identified matches, to prompt the user to iteratively provide further clarification information to identify an optimal match from the identified matches.

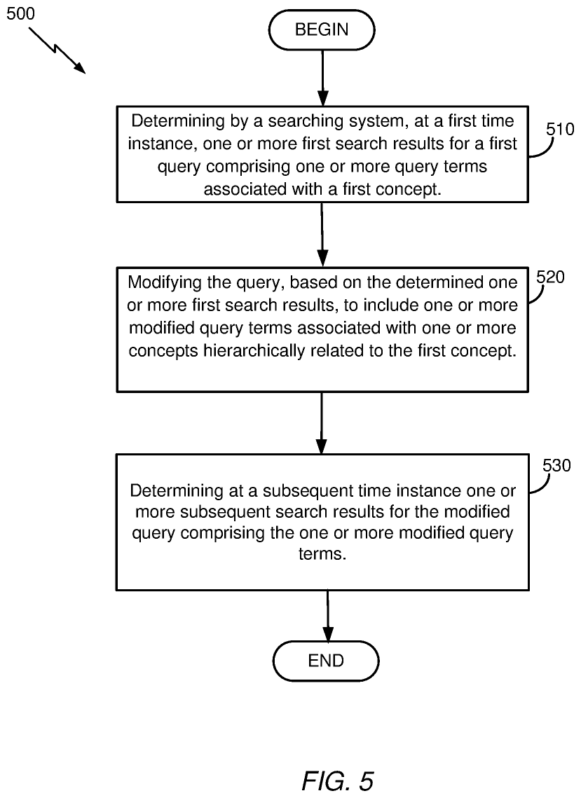

With reference next to FIG. 5, a flowchart of an example query modification procedure 500 is shown. The procedure 500 includes determining 510 by a searching system (such as the document processing agent 110), at a first time instance, one or more first search results for a first query comprising one or more query terms associated with a first concept. It is to be noted that the first concept may not be expressly included in the query, and therefore that first concept may need to be discovered or identified using, for example, a machine learning model trained to map query terms/words into pre-defined concept labels (such concept labels may define a pre-determined ontology).

The procedure 500 additionally includes modifying 520 the query, based on the determined one or more first search results, to include one or more modified query terms associated with one or more concepts hierarchically related to the first concept, and determining 530 at a subsequent time instance one or more subsequent search results for the modified query comprising the one or more modified query terms. The first concept and the hierarchically related one or more concepts may be arranged in an ontology (e.g., defined through an implementation of one or more machine learning models trained to produce labels representative of the hierarchy of concepts).

As noted, the query modification system may be configured to implement a backoff query directed to a broader concept than the initially received query. Thus, in various examples, modifying the query may comprise including in the modified query revised query terms to cause the searching system to search content directed to a broader concept that is at a parental hierarchical level in relation to the first concept. In such examples, modifying the query may include modifying the query to include revised query terms directed to the broader concept in response to a determination that fewer than a threshold number of respective one or more answer scores computed for the one or more first search results exceed a score threshold representative of a satisfactory answer.

Alternatively, if the initial receive query is too general (resulting in unsatisfactory answers), a drill-down process may be implemented to construct queries directed to more specific concepts than what the initially received query is directed to. Thus, modifying the query may comprise including in the modified query revised one or more terms to cause the searching system to search for content directed to one or more child concepts that are at a child hierarchical level in relation to the first concept.

In various examples, the method may further include presenting to a user multiple search results for the first query. In such examples, modifying the query may include modifying the query to include drilled-down query terms determined for one of the multiple search results selected by the user. The drilled down query terms are directed to concepts at a lower hierarchical level than the first concept. The method may further include determining after obtaining the one or more subsequent search results for the modified query whether to re-present the multiple search results for the first query or to further modify the modified query based on further drilled down concepts at a child hierarchical level of the lower hierarchical level.

As noted, an example implementation to realize a drill-down procedure is the visual Q-A implementation, in which the query produces a set of Q-A pairs that relate to concepts at a lower hierarchical level than the question contained in the query submitted by the user. In this example implementation, presenting to the user the multiple search results for the first query may include identifying multiple question-answer pairs relevant to the first query that are additionally associated with concepts at a next lower hierarchical level than the first concept, and presenting to the user at least some of the multiple question-answer pairs. Modifying the query to include drilled-down query terms may include modifying the query based on a question portion of a question-answer pair selected from the at least some of the multiple question-answer pairs.

The method may further include iteratively repeating the modifying and determining of search results based on answer scores computed for respective search results in search iterations. In some examples, modifying the query may include determining, based on a machine learning hierarchical concept-identifying model configured to generate resulting labels defined in a hierarchical ontology, the one or more hierarchical concepts from the hierarchical ontology in response to the first query. In various examples, determining the one or more hierarchical concepts may include generating, according to a machine learning concept-identifying model located upstream to the machine learning hierarchical concept-identifying model, one or more labels representative of the first concept associated with the query, and processing the one or more generated labels using the machine learning hierarchical concept-identifying model to determine the one or more hierarchical concepts.

In another example embodiment, query modification may be implemented through an interactive disambiguation process. Thus, modifying the query may include identifying one or more ambiguity categories associated with multiple matches from the one or more first search results, at least one of the one or more identified ambiguity categories being associated with at least some of the multiple matches and including different respective values associated with the at least some of the multiple matches, obtaining disambiguation information relevant to the at least one of the one or more identified ambiguity categories, and selecting at least one of the multiple matches based on the obtained disambiguation information relevant to the at least one of the one or more identified ambiguity categories. Obtaining the disambiguation information may include one or more of, for example, obtaining query contextual information for the first query and/or or generating prompt data to prompt a user to provide clarification information. Selecting at least one of the multiple matches may include selecting at least one of the multiple matches based, at least in part, on the query contextual information and/or on the clarification information provided by the user in response to the generated prompt data.

### 4 Query Rewrite for Improved Searching-Query Expansion, Query Extension, and Query Segmentation

A second approach, which optionally be combined with the backoff and drilldown approach, and which may be incorporated into the architecture described above, makes use or one or more query rewriting approaches to improve searching performance.

The approach makes use of one or a combination of multiple approaches for generating secondary queries from an initial query in order to improve searching (e.g., question-answer searching) performance. In some situations, the quality of search results is adversely impacted due to the submitted query being too informal (e.g., being too terse, for example when the user submits a keyword instead of a well-formulated question or query), or too verbose (when a user submits a multi-part query that includes irrelevant information). In another situation, a user may be searching for information that potentially can be expressed in different ways (due to the ubiquity of the underlying concept). The various processes described herein are directed to the automatic derivation of alternative ways to present a query for a particular concept(s) contained in the submitted query.

An example first approach to improve the quality of the search results that can be obtained from an initial query includes automatically rewriting the initial query into a set of semantically-similar possible queries. In embodiments of this first example approach, at least some of the alternative query possibilities (also referred to as a secondary or supplemental queries) are executed (e.g., the queries may be transformed according to the transform model(s) used to convert the source content into transformed content during document ingestion) and the results are then scored. The answer associated with the highest scoring option may be presented as the final answer to the initial query. A second example approach for improving searching performance is directed to queries that are short (e.g., the query may lack some of the typical wording that accompany natural language questions, such as interrogative words, wording specifying some intent or desire of the user for information, etc.), and instead include keywords such as a product name or any entity (or synonyms thereof). In these situations, where the interrogative wording or a question intent is missing, the query is extended by prepending an intent to the query. In situations where the document, i.e., the task at hand, has multiple plausible answers for more than one intent or interrogative associated with the keyword, multiple prepended queries can be created and separately executed (and the best scoring answers/matches can then be provided as output to the user). A third example approach for improving searching performance arises in situations involving a verbose and disjointed input submission from the user, where the submitted user's input may be directed to multi-purpose question segmentation with atomic pieces that are separately answerable (e.g., individually answerable). For example, an original query that includes multiple query terms (that may not all be related or relevant to each other, as may happen in verbose queries with disjointed terms) are segmented into several queries that each are directed to different concepts (or entities). It is to be noted that in various examples, an initial query may be processed using multiple query re-write approaches. For example, a verbose query may be segmented into multiple queries (e.g., under the third approach discussed herein), and then one or more of those queries may be used to generate supplemental queries with semantically equivalent meanings. A fourth example is the case of co-reference resolution, which is particularly important in the context of multi-turn dialog. A user may refer to an entity or action which was mentioned earlier in the dialog by a pronoun. Replacing that pronoun with the antecedent in the current query may result in a better answer. For example, if the dialog flow looks like: “[User] Which US state has the highest population? [System] The US state with the highest population is California. [User] What is its population?” In this example, the pronoun “its” is ambiguous, but likely refers to “California.” Replacing “its” with “California's” in the final turn could lead to a better answer than if the pronoun “its” was left in the second-turn of the user's query.

With reference to FIG. 6, a flow diagram illustrating an example query re-write framework 600 to improve searching quality. Generally, the framework 600, which may be implemented as part of the query processing module 136 of FIG. 1 (or as part of one of the other modules of the document processing agent 110), is configured to obtain by a searching system a first query comprising one or more first query terms that are each associated with a respective first semantic meaning, derive one or more secondary queries that each include at least one secondary query term with a respective secondary semantic meaning equivalent to the respective first semantic meaning of the one or more first query terms of the first query, and perform searches for the one or more secondary queries to determine respective answer data.

More particularly, as depicted in FIG. 6, a user-constructed query 602 is received, for example via the interactive user query interface 130. The user-constructed query is then analyzed, by a query analysis unit 610 (which, as noted, may be a process implemented at the query processing module 136 of FIG. 1) to identify any deficiencies in the user provided query 602 that could be ameliorated through one or more re-writing processes/approaches described herein. The analysis can include operations to, for example, count the number of words comprising the query, identify the inclusion or lack of query-related wording (e.g., interrogative words, like “what,” “who,” etc., words/expressions indicating) determine the number of identifiable concepts or entities, and so on. In various examples to determine if a query needs to be segmented into multiple queries (due to verbosity of the submitted text), the determination of identifiable concepts can be done by masking out common words that are often included in queries, to yield resultant isolated words (corresponding to concepts or entities). The resultant isolated words can then be analyzed to identify ontological labels and relationships between the various isolated words or corresponding labels. For example, this analysis can be performed by a machine learning system that is trained to generate, from the resultant isolated words of the query, ontological labels and their relationship (e.g., expressed as score indicating relatedness or closeness between a group of labels). A score indicating the existence of a relationship between the words analyzed (e.g., in a query such as “how do you replace a battery on a dell laptop?,” the words “dell,” “laptop,” and “battery” may result in a high relatedness score) would imply that the words of the query relate to a single query. Conversely, if the analysis indicates a more remote relationship between the words (or no relationship) may indicate that the submitted verbiage of the user's input query possibly encompasses multiple different queries that should be separately searched (by performing a segmentation-type re-write process on the submitted query, as will be discussed below in greater detail).

With continued reference to FIG. 6, based on the results of the analysis (performed at block 610), one or more downstream query re-write processes are performed. As noted, a first query re-write process that may be implemented (as depicted at block 620 of FIG. 6) is the query expansion approach to generate supplemental queries from an original query, in order to achieve the best possible retrieval accuracy in a question answering system, and thus achieve a good (and preferably the best) match between the original input query and the document to be searched. Small changes in the language of a query may result in different qualities of match with the document. The process performed at block 620 may be invoked/performed in response to a determination that the original query 602 is substantially directed to a single central concept (as may be determined by a concept-identifying machine learning system, or using some other implementation of a natural language processing system). In various examples, another rule or criterion that may cause the use of the query expansion process of the block 620 may be an initial determination that the concept that is to be searched is a commonly searched term that is associated with a number of synonym (as may be determined according to tables accessible by the query analysis at the block 610 that maintains lists of commonly searched concepts/terms and the degree to which such concepts/terms have equivalent terms).

In a question-answering system, questions may be, in some embodiments, fused with each chunk of the underlying source document during ingestion and fed into a transformer model (which may be based on different types of language models, such as BERT; vectorized the Q-A pairs may also be provided according to different content resolution). The chunk resulting in the highest score is returned as the top answer. Small differences in the language surface forms between the document and the query may affect the scores. For example, question such as “What time is supper served?” may score lower than the question “What time is dinner served?” if the document refers to the evening meal as “dinner” rather than “supper.”

To address the above challenge, under the query expansion approach the initial query is expanded (at the box 620 of FIG. 6) into a set of semantically similar queries which have different surface forms. The expansions may be derived from a pre-defined dictionary of synonyms or may be discovered automatically, for example by taking the N-best scoring words filling in a blank in a masked language model. Furthermore, any canonicalization that has been performed on the document, for example to map all occurrences of “P.C.” to “PC” (similarly to the implementation discussed above for the cleansing and normalization procedures) may be applied to the query as well, forming another rewrite to be scored.

Once a set of possible rewrites is determined, the rewrites (and optionally the original query) are run against the document (at box 680) to generate answers 682, from which the answer with the highest score across all answers, for all versions of the query, may be chosen. Alternatively, the top N answers (where N is a pre-determined value greater than 1) produced by searching the original query and the one or more supplemental queries generated by the expansion process.

For example, suppose a question posed through a query mentions the word “COVID.” This term has semantically equivalent terms such a s “COVID-19,” “Corona virus,” and so on. Each of these terms, although they refer to the same concept (they are semantically equivalent) may result in different search results. Thus, the best answer for the user's query may not be the answer that would have been identified through the original query term of “Covid.” Accordingly, the query expansion process generates supplemental queries in which the word “Covid” is replaced with semantically equivalent terms (and similarly, other terms may be replaced by synonymous terms) that are directed to the same concept and are semantically equal. The different queries resulting from this replacement/substitution, as well as the original query, are executed to generate an expanded set of answers from which the best answers can be selected.

Next, in situations where the original query (provided at data block 602) is overly terse, as may be determined at the query analysis block 610 according to the number of words in the original query, or based on whether query-formulating words and expressions (such as interrogative words, or expression of intent) are missing from the original query, the query extension process (illustrated at block 630) may be performed. Under the query extension approach, intent statements for keyword/entity, interrogative wording, and other types of query-formulating recitation, can be added (prepended or padded) to the query wording submitted by the user.

Without the addition of query-formulated wording, the search engine (e.g., implemented as part of the query processing module 136 of FIG. 1) may return an unmanageable number of answers that are each associated with (and have some relevance to) the terse query submitted by the user. However, for a query lacking query-formulating wording, scoring the returned answered may be more difficult because the short query may match well with a lot of different answers (it will be appreciated that another way to handle terse queries is through the drilldown/backoff processes described earlier).

Thus, for example, if a query statement (provided at the block 602) says “RTX 3080,” a meaning or definition of what RTX 3080 (determined from an ontology or a dictionary, for example) can be prepended (or otherwise added) to the query. If the query term is determined to be an object that is associated with some typical use (e.g., a piece of hardware may be associated with the acts of “ordering,” “buying,” “installing,” “using” the hardware), the definition and/or intent statement associated with the query term can be prepended to the original query language submitted by the user to create a modified queries with standard language phrases to try to steer that query in a particular direction. As another example of adding intent statements to short entity questions, the initial query (or query chunk, if that chunk was harvested from a lengthy query statement) of “Dell laptop” may be transformed, through the prepending of an intent statement, into the resultant query “I need help with Dell laptop.” In this example, the inclusion of “need help” can steer the search into appropriate user manual content to retrieve appropriate answers.

The statement of intent (or some other appropriate query-formulating wording) may be determined based, in part, on available contextual information associated with the query, or the user submitting the query (such information can be provided to, derived or maintained by the framework 600). For example, if previously submitted queries by the user were directed to buying (shopping) various other computing devices, the query extension block may infer (using a machine-learning system, a rules engine, or some other implementation) that the user is seeking shopping information with respect to the “Dell laptop” that was included in the submitted query. In this example, the query extension process may derive an extended, supplemental query of, for instance, “how much does a Dell laptop cost in stores near me?” or “where can I buy a Dell laptop near me?” Examples of contextual information that can be used to perform query extension (i.e., to add query-formulating expressions to the otherwise terse query submitted by the user) include contextual data associated with the query or user (such as location information, personal and device information associated with the query submitted or the user, etc.), information associated with recent query transactions (including the query text of recently queries submitted by the user or a group of users), information captured through various sensors on devices used by the user (e.g., image information showing the scene being viewed by the user, or showing captured barcode or QR codes), and so on.

Turning back to FIG. 6, and as discussed above, another query re-write approach is the query segmentation approach implemented through block 640. Consider a scenario in which a verbose and disjointed query comes in (possibly as a result of a speech recognition transcription procedure applied to a capture speech message) that says “Oh, hey, yes, I'm calling because I'm glad that I was on hold so long, I'm glad I can now remember why I called, I can barely remember, but I got my son a laptop for his birthday, . . . and anyway, I want to know, how do you plug in the laptop?” In this example, the key part of the query is the very last part asking about plugging in the laptop. However, because of the lengthy introduction preceding the key part of the query, the Q-A system might retrieve irrelevant answers as it tries to match the earlier parts of the message to the content being searched. To mitigate the challenge of having a long garbled query, the query may be truncated by creating supplemental queries in which different query terms, that appeared in the original query message, are removed, and the different queries (e.g., the original and truncated variants) are executed to yield an expanded set of answers from which the best ones (e.g., highest scoring ones) can be selected.

In another example, a query may include multiple questions, or multiple statements, grouped together (possibly received from multiple users). By doing some parsing, the multi-question (multi-statement) query can be broken into standalone, atomic pieces that can be separately searched, increasing the odds that one of the parsed queries will correspond to the main idea for which the query was formed, and return relevant search results.

As noted, the query segmentation process of the block 640 may be invoked/performed in response to a determination that the query submitted by the user includes multiple concepts with relatively low relatedness (as may be indicated by relatedness scores, e.g., computed by a machine-learning relatedness model, between pairs of key concepts identified in the query being less than some threshold relatedness score). The identification of concepts or entities in a query and their relatedness may be performed upstream (at the query analysis block 610) that may have been implemented by a rules engine or a machine learning system, and the analysis information may then be forwarded to the block 640. The block 640 may then perform the actual query segmentation based on the analysis information provided by the block 610 (to derive supplemental queries directed to the different identified concepts, or their semantic equivalents, from the original query). The query segmentation processing thus generates multiple parsed queries that can then be separately searched (at the block 680).

Thus, under the segmentation approach a lengthy question is parsed into, for example, noun phrases, and the separate segmented queries compete with a scoring or confidence mechanism, to surface relevant answers. A long monologue by a caller, or by a questioner could turn into a set of chunks, one of which may include the actual question the user(s) intended to ask. After executing the query chunks (by the Q-A system), some of those query chunks will yield relevant answers (with some of those relevant answers nevertheless containing redundant information resulting from potential overlap between parsed queries), but pooling the answers together will more likely give a relevant answer as opposed to getting a relevant answer from the original verbose query (in the hope that the question-answer system can infer meaning out of a long sentence).

Consider another example illustrating the benefit of parsing an original query (containing multi-purpose questions) into smaller chunks. In this example an emotional person might say “Who is the stupid CEO of ABC company?” The word “stupid” could have many implications if the system searches for responses with that word. The idea is that a query that has multi-purpose, or multi questions, multi-information, portion can be broken, and some orchestration procedure can be used to decide what is the best thing (answer) to return.

Another query re-write procedure that may be implemented by the framework 600 is the pronoun substitution procedure represented by a block 650. As noted, users may consciously, or inadvertently, replace proper nouns they have been using with pronouns. For example, during a multi-turn interactive session between a user and the information retrieval system, the user may revert to using a pronoun in place of a noun that was used earlier, e.g., replacing “dell laptop” that was used earlier as the subject of the query, with the pronoun “it” in follow-up queries. To avoid poor resultant search matches for a query that uses a pronoun instead of a proper noun, the pronoun substitution block 650 is configured to identify the use of ambiguous pronouns within the query data of a current query, and determine if the ambiguous pronoun can be mapped, based on contextual information available to the block 650, to a proper noun. For example, in a multi-turn interaction between a user and the information retrieval system, the block 650 may include a log of the questions and answers produced by and for the current user. The block 650 determines a likely antecedent proper noun (e.g., using a natural language processing engine to analyze the grammatical constituents of earlier questions and answers), and substitutes the pronoun used in the current query (question) with the likely antecedent proper noun.

In some situations it may happen that there are multiple possible likely antecedent proper nouns that correspond to a pronoun in the current query, and that the natural language processing engine cannot definitively resolve (at a satisfactory confidence level) which is the correct pronoun to use. In such situations, the block 650 may produce several substitute queries, each with one of the possible likely pronouns identified, and execute those substitute queries at the search block 680. The information retrieval system may then handle the resultant matches according to its regular operating procedure (e.g., select the top N answers that exceed some matching score threshold).

Thus, in example embodiments, the controller of the searching system (e.g., the query processing module 136) configured to derive one or more secondary queries may be configured to identify at least one pronoun from the first query terms, and determine, based on contextual information associated with one or more of the user or the first query (e.g., earlier turns of an interactive session conducted by the current users, other types of information regarding the user or group of uses, etc.), a respective at least one proper noun corresponding to the at least one pronoun. The controller is further configured to replace the identified at least one pronoun in the first query with the determined respective at least one proper noun to generate a substitute query. That substitute query can then be submitted (potentially with the original query) to the searching system to produce the candidate answers 682.

A further example approach to re-write a query is based on paraphrasing of the entire query rather than merely replacing various query terms (according to, for example, one or more of the approaches discussed in relation to blocks 620, 630, 640, or 650 of FIG. 6). Such paraphrasing can be performed with a generative large language model (LLM), which may be implemented locally (e.g., at the document processing agent 110 of FIG. 1) or may be implemented remotely at a third-party server (e.g., ChatGPT application). Under this approach, the entirety of the query is processed to produce a linguistically different query than that submitted, but with a substantially semantically equivalent meaning. Such a linguistically different query may produce queries that reflect other conventional ways to ask for the information that the query data provided to the query paraphrasing block 660 is seeking, thus increasing the query diversity (to increase the number of different ways that a particular request for information can be posed).

In some embodiments, the invocation of a generative language model may include generating a message (provided to a local LLM engine, or sent to a remote LLM server) that includes the query to be paraphrased, and further includes a command or a prompt (specifying a query rephrasing instruction) that instructs the generative large language model to modify the query text according to edit (configuration) data specified in the command or prompt. For example, for messages sent to ChatGPT, the message containing the content to be modified (in this case, the query data) may include a bracketed prompt specifying certain required characteristics for the desired output, such as the level of articulation (e.g., “[rephrase at a medium of perplexity]”; other options for the perplexity may be “high” or “low”). Other scaling and/or configuration parameters may also be used. The generated message is then provided to the generative language model system (e.g., when sent remotely, the message would be transmitted via a wired or wireless network link).

Thus, as depicted in FIG. 6, the framework 600 further includes the query paraphrasing block 660 which may directly implement a generative LLM engine, or may simply implement a procedure to formulate a paraphrasing request (according to syntax compatible with a local or a remote generative LLM engine), and communicate the formulated request to the generative LLM. The paraphrasing request may be produced according to either the original query 602, or according to any of the secondary questions/queries that were formulated using one or more of the blocks 620, 630, 640, and/or 650). Whether implemented at the block 660, or communicated to some other local or remote LLM engine, the resultant paraphrased is produced at the output of the block 660 and provided to the search block 680, which in turn produces answers to the paraphrased query (and for any other query provided). Accordingly, in various examples, the controller of the searching system (such as the document processing engine 110 of the question answering system 100, or more particularly the query processing module 136 of FIG. 1) configured to derive one or more secondary queries may be configured to generate a paraphrase message comprising the first query and one or more required output characteristics for a resultant query paraphrasing of the first query, and provide the paraphrase message to a generative large language model system configured to generate a paraphrased query based on the first query and the one or more required output characteristics.

As further illustrated in FIG. 6, query re-write processing can include additional types of query modification processes (represented by block 670) seeking to improve the quality of returned answers by re-writing queries to generate secondary queries that turn poorly formulated queries into more meaningful (albeit semantically equivalent) queries that might be better targeted at the content on the data repositories being searched. Additionally, in various examples the resultant queries of the various blocks 620, 630, 640, 650, 660, and 670 may optionally be provided (via return paths 622, 632, 642, 652, 662, and 672, respectively) to other processes to generate additional variants of the queries generated by each of the blocks. For example, the parsed queries resulting from the query segmentation operations at the block 640 produce one or more of the atomic pieces (the parsed queries) that can be extended to include query-formulating wording (such as a statement of intent, as described above) that is pre-pended to the keywords/entities for the respective one or more atomic pieces at the query extension module 630. In another example, any resultant one or more queries at the outputs of the blocks 630, 640, 650, 660, and 670 may be provided to the query expansion block 620 to further generate queries with different, but semantically equivalent, wording representative of one or more terms/concepts of the queries received (from the output of some of the other query re-write blocks).

In some embodiments, some or all of the various query re-write processes described herein in relation to blocks 620, 630, 640, and/or 650 may be performed by one or more generative LLM engines configured to receive a first query and a command to generate a secondary query according to the query expansion, query extension, query, segmentation, and/or pronoun substitution processes (or any other query re-write process). In such embodiments, the generative LLM may in effect emulate the operations described herein with respect to the query re-write blocks 620, 630, 640, and/or 650. Additionally, secondary queries generated by the generative LLM engine(s) can be feedback (via feedback path 662) to be operated upon (in accordance with a respective command specifying the re-write operation to be performed) in order to generate further secondary query variants. This iterative process may continue until some query diversity criterion (e.g., a pre-determined number of generated distinct variants) is met.

Next, with reference to FIG. 7, a flowchart of a procedure 700 for information retrieval based on query re-writes of query submissions is shown. The procedure 700 includes obtaining 710 by a searching system (e.g., via the interactive user query interface 130 of the document processing agent 110 of FIG. 1) a first query comprising one or more first query terms that are each associated with a respective first semantic meaning. The procedure further includes deriving 720 (e.g., by query re-write processes implemented as part of the query processing module 136) one or more secondary queries that each includes at least one secondary query term with a respective secondary semantic meaning equivalent to the respective first semantic meaning of at least one of the one or more first query terms of the first query, and performing 730 searches for the one or more secondary queries to determine respective answer data. In various examples, generated secondary queries may themselves be processed by the different query re-write approaches so as to generate further alternate queries (effectively second generation queries). Thus, in such examples, the procedure 700 may further include determining for at least one of the one or more secondary queries one or more tertiary queries with respective one or more tertiary query terms having respective tertiary semantic meanings equivalent to the respective second semantic meaning of at least one query term of the at least one of the one or more secondary queries.

As discussed above, several different re-write approaches (to derive the secondary queries) are proposed in relation to the overall framework of the procedure 700 (under which alternative queries, that are semantically similar to the submitted query, but which may identify better answers) are formed and executed. In a first approach, submitted query terms are re-written (according to a dictionary of terms that may be implemented through a database or a machine learning system) to generate queries with alternative semantically similar query terms. Under this approach, different ways of forming the queries are tried to improve the likelihood that one alternative query might be more commonly used (in professional or everyday parlance), and thus may yield better quality answers. Accordingly, in examples of the this first query re-write approach, the first query may include a particular first query term with a particular first semantic meaning, and deriving the one or more secondary queries may include determining one or more supplemental queries each with respective one or more supplemental query terms different from the particular first query term, with the one or more supplemental query terms each having an equivalent semantic meaning similar to the particular first semantic meaning. Determining for each of the one or more supplemental queries the respective one or more supplemental query terms different from the particular first query term may include determining the respective one or more supplemental query terms, associated with semantic meanings equivalent to the particular first semantic meaning, based on matching the particular first query term to terms included in a pre-defined dictionary of query terms. In various examples, determining for each of the one or more supplemental queries the respective one or more supplemental query terms different from the particular first query term may include determining the respective one or more supplemental query terms, associated with semantic meanings equivalent to the particular first semantic meaning, by identifying N-best scoring words for the particular first query term using a masked language model, where N≥1. Performing searches for the one or more secondary queries may include executing searches for the first query containing the particular first query term further and the one or more supplemental queries, computing matching scores for answers resulting from executing the searches for the first query and the one or more supplemental queries, and selecting one or more of the answers with respective one or more highest computed matching scores.

A second proposed query re-write approach relates to segmenting query submissions that are overly verbose or disjointed, and may include several unrelated sub-concepts or sub-queries. Thus, in the second approach the first query may include multiple query terms, and deriving one or more secondary queries may include parsing the first query into multiple supplemental queries that each includes different subsets of the multiple query terms in the first query. Performing searches for the one or more secondary queries may include performing searches for the multiple supplemental queries to determine respective answer data. In various examples, parsing the first query into the multiple supplemental queries may include analyzing the first query, including: determining the multiple query terms in the first query, and identifying the multiple supplemental queries according to a determined level or relatedness between two or more of the multiple query terms in the first query. The second re-write approach may further include computing matching scores for answers resulting from performing the searches for the multiple supplemental queries, and selecting one or more of the answers with respective one or more highest computed matching scores. The second approach operations may further include determining statement of intent associated with at least one subset of the different subsets of the multiple query terms, and adding the determined statement of intent in a supplemental query, from the multiple supplemental queries, associated with the at least one subset of the different subsets of the multiple query terms. Adding the determined statement of intent comprises prepending the statement of intent to the supplemental query.

As noted, a third re-write approach seeks to expand overly terse queries with query-formulating expressions so that the expanded queries can provide more targeted, and thus more relevant answers. Under this approach deriving one or more secondary queries may include determining a query-formulating expression associated with at least one query term from the one or more first query terms of the first query, and adding the determined query-formulating expression to the at least one query term to generate a supplemental query. Performing the searches for the one or more secondary queries may include performing a search for the supplemental query comprising the at least one query term and the query-formulating expression to determine answer data. The query-formulating expression may include one or more of, for example, a statement of intent associated with at least one query term, and/or an interrogative expression. Determining the query-formulating expression associated with the at least one query term may include determining the query-formulating expression based on the at least one query term and contextual information associated with one or more of, for example, the user (including also computer groups the user is associated with, or the first query).

Two additional query re-write approaches include an approach that mitigates ambiguity resulting from use of pronouns instead of proper nouns, and another approach that generates paraphrased variants using a generative large language model (LLM) system (such as ChatGPT). Thus, deriving one or more secondary queries may include identifying at least one pronoun from the first query terms, determining, based on contextual information associated with one or more of the user or the first query, a respective at least one proper noun corresponding to the at least one pronoun, and replacing the identified at least one pronoun in the first query with the determined respective at least one proper noun to generate a substitute query. For the generative LLM approach, deriving one or more secondary queries may include generating a paraphrase message comprising the first query and one or more required output characteristics for a resultant query paraphrasing of the first query, and providing the paraphrase message to a generative large language model system configured to generate a paraphrased query based on the first query and the one or more required output characteristics.

### 5 Hierarchical Collections and Sources

Yet another approach, which may optionally be combined with one or both of the backoff and drilldown approach and the query rewriting approach described above, is tailored to address use of hierarchical collections and sources.

This hierarchical collection approach implements a high level information architecture to facilitate organization of data collections that allows Q-A searches to find good answers not only based on matching criteria (e.g., proximity or similarity of a query to data content, ingested or otherwise), but also based on user or group preferences to certain data collection, e.g., to score certain answers that are located in preferred data collections more highly than they would have been scored based strictly on regular matching criteria. The framework allows information to be organized to optimize speed, and disaggregate of data.

Data exists in a complex multidimensional context that may include location of a data record in a hierarchy of folders, permissions as to who has access to the data record, information about the data type or structure (procedure, definition, etc.), the user characteristics related to the data record (owner, author, intended audience), and so on. The relevance of a particular piece of information to a particular person asking a question (the “user”) is dependent not just on how well the answer matches the question, but also on the characteristics of the user and the situation. These characteristics can be dynamic. For example, a user who has access to a particular piece of information may not have access if the user is not logged in through a VPN. The best information for a new user may not be the best after they have been using the system for a month. Similarly, what is considered the best information for one user (from some organization or group, e.g., a company) may not be considered as the best information for another user.

Under the proposed data collection approaches, retrieving the most relevant answer typically requires imposing a data organization scheme and adding metadata to content, and then ensuring that the appropriate user data is available when the user is querying the system. When the user data is not available (and having that data would change the response), the system needs to be self-aware and either query the user or automatically adjust characteristics of the search. Implementation of data collection procedures can include, for example:
design of data organization to allow for dynamic selection of answers;
introducing efficient probabilistic filtering, making decisions based on match of user to content organization (change the prior probability of content groups/subgroups);
UI, flexibility, permissions based on user groups; and
sorting based on dynamic relevance (with such dynamic relevance determined, for example, based on dynamically modified preferences).

Consider a situation where a lot of documentation is available for searching that includes public information, and private information (e.g., repositories of business application content, such as Outlook™, or Slack™, created by an organization). When searching the content, the particular user may wish to prioritize searching for data collection belonging to the user's organization instead of generic/public content (or other collections of data provided by the vendor). The prioritization may be implemented so that private (proprietary) content is searched first, and only if no answer (e.g., satisfying a minimum scoring criterion, such as a closeness criterion or a transform-based distance, or TBD, criterion) is found (or not a sufficient number of answers are found) can vendor or public data collections be searched.

To further illustrate, consider a situation where for various content portions (a frequently-asked-questions content, a retrieval view content, etc.) metadata is created and attached to the content that identifies information such as the author, the date of the publication, and other types of contextual information that can be used with business logic to filter and decide which content to search. Under the data collection approaches searching operations become probabilistic. This can be achieved by assigning more weight to preferred collections versus the other collections. In some examples, the preferences, and thus weights, can change dynamically (for example, based on the time of day, or the specific users of the organization submitting the queries). Preferences do not need to be explicitly specified, and instead can be implicit (e.g., based on contextual information of a query, a user, location, etc.) and may be determined automatically based such implicit information.

The dynamic changes of preference data, and/or contextual information, to achieve probabilistic determination of search results (to get a mixture of answers from different collections that are not dependent exclusively on quality of answers) can be achieved through a knowledge bot (an IRQA connected to some existing chatbot). For example, a user submits a query at a first time instance and determines a set of answers. Later, the same or a different user of the same organization may submit a similar query, and receive another set of data. The user can choose prior to the later time instance different probabilities and change the preferences, to thus control the identified search results and/or the order in which they are presented.

In various examples, the dynamic adjustment of preferences and searching parameters may be performed internally within the Q-A system. For example, with the content available to be searched there may be a content group, which is a collection, that may include many content pieces. These pieces can be selected by the user (customer) who can even provide at any point in time some probability specification (e.g., “this collection should be given 80% now.”). Later, the same user (or another member of the same organization as the user) may dynamically change the probability (the proportion or weight) to specify that “this collection should be given 20% weight.” This dynamic change can be provided by communicating to the Q-A system (e.g., through a user-system interface) an API call changing the probability distribution that the user wants to apply. This dynamic adjustment can be thought of as specifying a prior/priority (e.g., “I want this collection to have a higher prior now, and that collection have a lower prior”), with the user(s) able to change the priors of the collection at any time. An advantage of being able to change preferences/priority information internally through dynamic interaction with the Q-A system is that the cost of running searches may be assessed based on the number of interactive sessions/calls an organization is conducting with the Q-A system (e.g., when the Q-A system is a cloud service that serves multiple customers and organizations). By being able to modify preference parameters interactively during an API session, users can adjust the nature of the searches on the fly, and adjust the quality of the results in response to delivery of an initial set of answer data to proactively steer the searching to different data collections. This feature, therefore, improves the quality of identified answer data that can be obtained from a single interactive session, instead of having to re-submit queries in separate sessions to adjust the data collections that are to be searched.

In various examples, when searching data content (e.g., when applied indiscriminately to the entire, or substantial part of the content corpus managed by the Q-A system) the Q-A system may perform a fast search (i.e., a coarse search, such a low resolution BERT-based search) to identify potential answer candidates (those candidates can then be used to conduct a detailed, high resolution search to identify the best/closest matches). In example embodiments, the data collection procedure may be implemented so that during fast search stage of the searching process candidate answers from various data collections are identified according to proportions determined from preference data. For example, if the user indicates explicitly or implicitly that 80% of search activity needs to focus on the user's organization's private data, the Q-A system may perform a fast search to identify 80% of the potential answer candidates (subsequently subjected to a detailed search) from the data collections belonging to the user's organization. This proportion criterion needs to be satisfied regardless of the quality of the search results (i.e., the matching distance between the query and the Q-A content being searched) so that the priorities indicated by the user(s) play a role. In an example, the fast search is performed on the entire data corpus, and the preferences/priors are subsequently applied to return the appropriate proportions of answers from preferred data collections and the other (remaining) data collections. In another example, fast searches can be applied to specific data collections according to the determined preferences/priors.

Thus, the Q-A system causes retrieval of sets of collections according to some provided preferences, priors, or a weighting scheme so that search results are either preferred from one another to ensure that there is a minimal answer results representation from each of the collections. The determined preferences therefore cause execution of queries that span multiple collections.

It is to be noted that there are all kinds of reasons that priors on different collections could change, thus requiring an implementation of an appropriate interface through programming and/or a user interface (UI) where users can manipulate the outcome of the Q-A system based on the priors they would like to apply to the preferred collections that, in some embodiments, the users (or their organizations) have built themselves for storage on the Q-A system.

The data collection approach allows for the melding of answers/search results spanning different sources to include answers that may not have scored well, but nevertheless may be relevant because they are found in proprietary content of the user or his/her organization. Preferences or priors can be dynamically adjusted individually or per group of users. The data collection implementations accommodate preferences for different collection sets. E.g., an HR user of a particular organization may have particular preferences that cause data searches to focus more (i.e., to prefer) data from HR manuals, but may nevertheless also cause financial reports of the organization to be searched according to a proportion that is determined from the particular preferences specification (e.g., a query launched by an HR user has a 90% chance, for example, of finding an answer in the collection of HR manuals, and therefore 90% of the answers results should come from that collection). Similarly, other user roles (admin, super admin) would result in different preferences (implicit or enforced based on prior knowledge). Preferences could also be dynamically tied to some frequency of usage that may be visible only to the users/customer. There are a lot of external priors that can be incorporated to implement the mechanism to set preferences for searching data collections in an information retrieval system (e.g., a Q-A system).

To further illustrate the hierarchical collections framework, consider FIG. 8 showing a flow diagram illustrating an example searching framework 800 that uses preference data (defining a data collection hierarchy and preferences for a particular user or group of users) to produce higher quality search results that are better aligned with the users' likely needs. Generally, the framework 800, which may be implemented as part of the query processing module 136 of FIG. 1 (or as part of one of the other modules of the document processing agent 110), is configured to obtain query data (that includes one or more query terms) to search a question-and-answer (Q-A) searching system storing content (e.g., as DOM data objects such as the objects 142a-n stored in DOM repository 140 depicted in FIG. 1) organized in a plurality of data collections. The framework 800 is further configured to perform a search according to the obtained query data to determine answer data from the content in the plurality of data collections based on matching criteria for the one or more query terms and the content in the plurality of data collections, and further based on preference data indicating preferences for producing responses to the query data from the respective ones of the plurality of data collections.

More particularly, as depicted in FIG. 8, a user-constructed query 802 is received, for example via an interactive user query interface such as the interface 130 of FIG. 1. Some processing may be performed on the query terms (e.g., according to the processes described in relation to FIGS. 1-7, such as query re-writes, query drilldown or backoff, or checking a Q-A cache before searching transformed content) The query data (whether initially processed, or as-is) is then processed by a search query block 810 (depicted in FIG. 8) which may be implemented using the query processor (processing module) 136 of FIG. 1. For instance, the search query box 810 performs one or more machine learning vector transformation operation to transform the query into a vector space representation compatible with the transformed content stored in the repository to be searched. In some embodiments, and as will be discussed in greater detail below, the search query box 810 may be configured to first perform a coarse vector transformation, based on a BERT model or one of the other models discussed herein, followed by a fine-detailed transform to search the coarse-detail search results. The search query box 810 performs a search of the content repository 820 that includes a plurality of data collections 822a-n (the content repository 820 may be implemented similarly to the repository 140 of FIG. 1) to identify matches between the transformed query 802 (whether first modified, or in some way pre-processed, or as-is) and the content arranged in the repository in the various data collections. The execution of the search returns answers 830, which may include answers presented in semantic form, a particular visual form, and/or the vector-transformed form.

The identified answers in block 830 may be those portions of the content being searched that satisfy a minimal matching criterion (for example, the identified answers are those with a relevance score exceeding some pre-determined threshold). As noted above (e.g., in relation to FIG. 4) relevance/matching scores may be computed, for example, according to a distance measurements between semantic content of an answer and a corresponding question, according to a predicted output of a trained machine learning engine that assesses relevance of a question and a candidate answer, according to a computed Transform-Based-Distance (TBD) score between a question and an answer, according to a posterior probability equivalent of the TBD, or according to any other relevance derivation process. A particular question and answer pair with a high relevance score indicates a likelihood of a match between the query submitted and the content searched.

As illustrated in FIG. 8, in various examples, the search operations performed on the query (original or modified) may optionally incorporate preference indicators 846 derived by a preference analysis unit 840 based on available preference data obtained from various sources (as will be discussed in greater detail below). The preference indicators provided to the search query block 810 may include such information as the identity of the data collection(s) that should be searched first (e.g., proprietary data collections should be given preference over public or third-party data collections), weights that are to be applied to computed relevance scores (weighing matching scores for search results from proprietary data collection more heavily than non-proprietary data collections), and/or proportion values (e.g., percentages) specifying what proportion of the answers, to be included in the results returned to the users, need to have been determined from specific respective data collections. For example, when proportion values are computed and provided to the search query block 810 ahead of executing the search for the query provided, the search operations are controlled so that the number of results determined from any particular data collection corresponds to the respective proportion specified for that data collection, multiplied by a pre-determined number, N, representing the total number of results to be returned in the resultant output data (shown as block 860 in FIG. 8). To illustrate, consider a situation where the preference data determined specifies that 80% of the results should come from proprietary data collection a (822a), with the rest of the results (20%) being the responses, determined from non-proprietary data collection, and having the highest matching scores. Assume also that the output data returned to the user is to include a total of 100 search results. In this situation, 80 search results (regardless of whether they have a higher score than results determined from non-proprietary data collection) are added to the output data subset, and the top scoring 20 search results determined from the non-proprietary data collections are also added to the output data subset.

In another example illustration, the preference indicators may simply include the preference order information specifying the order at which data collections should be searched for results. Thus, if preference indicators specify that the data collection (a) (822a) should be searched first, followed by a data collection (n-j) (i.e., one of the plurality of data collections in the repository 820, with j being some arbitrary integer number), followed by the data collection (b), the search query block may perform a search of the query on the content of the data collection a (820a), and collect all search results with matching scores exceeding some threshold value. If the returned results from the data collection a include fewer than the maximum number of returned results, the search query block 810 will proceed to execute a search of the next specified data collection (in this case the data collection n-j). Accordingly, in embodiments in which the priority indicators include a priority list specifying an order at which to search the plurality of data collections, the searching framework 800 is configured to determine, based on the preference data, a priority list of an order at which to search the plurality of data collections. In such embodiments, the search framework is configured to determine search matches with computed matching scores exceeding a pre-determined score threshold from one or more data collections of the plurality of data collections according to the order specified in the priority list, and to return a maximum of a pre-determined threshold number of search matches such that lower priority data collections specified in the priority list are searched only when a number of returned matches from higher priority data collections is less than the maximum pre-determined threshold number.

If the preference data incudes proportion values for specified data collections (e.g., 70% for the data collection a, 15% for the data collection n-j, and 15% of the data collection b), and the maximum number of returned results is 200, the executed search will return 140 search results from the data collection a, 30 results from the data collection n-j, and 30 results from the data collection b. The searching operation may optionally require that the returned results have matching scores exceeding some pre-determined threshold, and may cause deviation from the specified proportions if one of the listed data collections does not produce enough search results with matching scores exceeding that minimum threshold.

As noted, the framework 800 may be configured to more efficiently search the data repository by implementing a multi-pronged searching procedure such as one based on a coarse-detail search, guided by preference information (such as identify of data collections and the searching order of those data collections, weights, and/or proportion values). Thus, in such implementations, searching operations may include performing a fast search on low resolution transformed data representations of the content stored in the Q-A system, to identify candidate answers with respect to which a detailed resolution data representations is available, selecting from the identified candidate answers a subset of preferred candidate answers based on the preference data (e.g., according to resultant preference indicators, such as the preference indicators 846, derived by the preference analysis unit 840 based on available preference data), and performing a detailed resolution search on the content stored in the Q-A system according to the subset of preferred candidate answers.

As further illustrated in FIG. 8, in various embodiments preference indicators 848 (which may be the same or different than the preference indicators 846 that is provided to the search query block to be used for performing the search) may be provided to a prepare output data block 850 to process the returned results/answers (whether or not preference data was used to determine those returned results) and prepare output data based on the preference data 848 applied to the returned answers 830. The preference indicators 846, and generally the preference indicators 848, are generated by a preference analysis unit 840. The preference indicators are derived based various sources of preference data that affect the searching and output data generation preferences and output data generation preferences, and can include the user's own dynamically specified preference information 842 (e.g., provided via the interactive interface 130 of FIG. 1), and context data regarding the user of the data collections (available from data provided as context info 844, or as information provided from the repository 820 via arrow 843). Thus, the preference data may include one or more of, for example, i) identification of data collections (such information may be provided by the repository 820 as the information 843 that manages the stored data collections, ii) specified user preferences of searchable content (this can be specified by the user identifying specific data collections, identifying specific types of data, excluding certain data collections, and so on), iii) accessibility of the identified data collections (e.g., whether a data collection is stored locally or remotely; this information may also be part of the information 843), iv) priority information associated with the identified data collections, identification of the one or more users associated with the query data (which could indicate what data collection the user may be interested in), v) access permission information for plurality of data collections (e.g., a user may not obtain search results from data collections he/she is not allowed to access), or contextual information (represented as context info 844 of FIG. 8) for the query (time/day information, query history information, and any other information that can provide clues as to which data collections may be relevant to the query).

The preference analysis unit 840 can compute preference information (as indicators) based on different modifiable processes that apply pre-determined rules or formulations, e.g., formulas that provide preference proportions, preference weights, or preference orders, as a function(s) of one or more of the different preference data items that are available. For example, the various preference data items can be converted into some common numerical domain that represents the preference, and a resultant converted values in the common domain can be weighed according to some pre-determined scheme (e.g., specific user preference input, can be converted into such a numerical domain and be weighed more heavily than, for example, date/time information that was also converted into the same numerical domain).

In example embodiments in which preference information is used to select or generate the output data, the resultant preference indicators 848 are provided to the prepare output data block 850, which applies the computed indicators (be it order information, weights, or proportion values) to answers returned from execution of the query search (via the search query block 810) to generate the output data 860. Thus, in various examples, the preference analysis unit 840 is configured to compute, according to a proportionality formulation applied to the preference data, answer-proportion-values representative of proportions of answers produced from content in respective ones of the plurality of data collections. The “prepare output data” block 850 of the framework 800 then outputs result data comprising answers selected from the plurality of data collections according to the computed proportions for the respective ones of the plurality of data collections. In different example embodiments, the preference analysis unit 840 is configured to compute for each of the plurality of data collection a respective weight value according to a weight formulation based on the preference data or proportion value. In such example embodiments, the “prepare output data” block 850 weighs the matching scores of the determined answer data based on the respective weight values applied according to which of the plurality of data collection the answers were determined from, and outputs result data comprising a pre-determined number, N, of answers having highest weighted scores.

With reference next to FIG. 9, a flowchart of a preference-based searching procedure 900 in a Question-Answering system (such as the system illustrated in FIG. 1) is shown. The procedure 900 include obtaining 910 query data to search a question-and-answer (Q-A) searching system storing content organized in a plurality of data collections, with the query data including one or more query terms. The procedure 900 further includes performing a search 920 according to the obtained query data to determine answer data from the content in the plurality of data collections based on matching criteria for the one or more query terms and the content in the plurality of data collections, and further based on preference data indicating preferences for producing responses to the query data from the respective ones of the plurality of data collections.

In various examples, performing the search may include computing matching scores for identified answers determined from the search according to closeness criteria applied to the query terms and the content in the plurality of data collections, and weighing the computed matching scores for the identified answers according to the preference data. In some example embodiments, performing the search may include computing, according to a proportionality formulation applied to the preference data, answer-proportion-values representative of proportions of answers produced from content in respective ones of the plurality of data collections, and outputting result data comprising answers selected from the plurality of data collections according to the computed proportions for the respective ones of the plurality of data collections. In yet additional examples, performing the search may include computing for each of the plurality of data collection a respective weight value according to a weight formulation based on the preference data or proportion value, weighing the matching scores of the determined answer data based on the respective weight value applied according to which of the plurality of data collection the answers were determined from, and outputting result data comprising a pre-determined number, N, of answers having highest weighted scores.

The preference data (provided from various sources, such as those depicted in FIG. 8, including, data maintained by a repository of the searchable content, context data relating to the users and/or to the query, user-provided interactive input) may include one or more of, for example, identification of data collections, specified user preferences of searchable content, accessibility of the identified data collections, priority information associated with the identified data collections, identification of the one or more users associated with the query data, access permission information for plurality of data collections, and/or contextual information for the query, the user, or a group of users. As noted, at least part of the preference data may be dynamically adjustable (e.g., can be specified during runtime) via an interactive user interface (such as interactive user query interface 130 of FIG. 1).

In some embodiments, performing the search according to the obtained query data may include applying the search to at least one of the plurality of data collections to identify matching answers satisfying one or more matching criteria, and in response to determining that there are fewer identified matching answers than a pre-determined threshold, applying the search to other collections in the plurality of data collections. For example, the at least one of the plurality of data collections may correspond to proprietary, non-public, data collection belonging to an organization, with that data collection given preference when searching for an answer.

In certain examples, performing the search may include performing a fast search on low resolution transformed data representations of the content stored in the Q-A system, to identify candidate answers with respect to which a detailed resolution data representations is available, selecting from the identified candidate answers a subset of preferred candidate answers based on the preference data, and performing a detailed resolution search on the content stored in the Q-A system according to the subset of preferred candidate answers. In such examples, selecting the subset of preferred candidate answers may include determining preference data percentage values associated with respective ones of the plurality of data collections, computing for each of the plurality of data collection a number-of-answers-value corresponding to the respective one of preference data percentage values applied to a pre-determined number, N, representative of a total number of answers to include in the subset of preferred candidate answers, and selecting from each of the plurality of data collection a respective computed number-of answers-value candidate answers having top matching scores.

In various examples, the method may further include determining, based on the preference data, a priority list of an order at which to search the plurality of data collections. In such examples, performing the search may include determining search matches with computed matching scores exceeding a pre-determined score threshold from one or more data collections of the plurality of data collections according to the order specified in the priority list, and returning a maximum of a pre-determined threshold number of search matches such that lower priority data collections specified in the priority list are searched only when a number of returned matches from higher priority data collections is less than the maximum pre-determined threshold number.

### 6 Question Relevance Detector

Another approach, which may optionally be combines with one or more of the approaches described above, and which may be incorporated into the overall architecture described above, relates to relevance detection. In some implementations, a follow up detector (also referred to as a relevance detector) is implemented in which the IRQA platform uses a transformer network to classify follow up questions (i.e., following preceding questions that typically contain more information and context, which the user may not include in any follow-up question). For example, the follow-up detector can be used for the purposes of multi-turn disambiguation when language contractions of ellipsis, CoRef, etc. are deployed by the users. At a minimum, when such functionality, namely, ellipsis, CoRef resolution, is not available, the IRQA system may be configured to simply responds that it cannot answer that question.

The question relevance detector performs a quick ambiguity/relevance classifications on queries to determine if a particular query is too ambiguous to process, or has enough clarity to return answer results with sufficient confidence in the quality of the answers (e.g., confidence that the answers returned are not nonsensical). The question relevance detector mitigates situations where out-domain detection and follow-up questions challenge the performance of the searching system. Under the question relevance detection approach, transformer technology can used to classify the query into, for example, three (3) classes of queries, namely, complete (non-ambiguous) in-domain query, out-domain query, and ambiguous-in-domain query (the classification may include additional class categories). Depending on the determined class of the query, different actions may next be taken by the searching system. For example, an ambiguous in-domain query classification will cause the Q-A system to either advise the user that the query is missing information (e.g., context), or may launch a disambiguation procedure. The detector can provide improvement in the searching accuracy of all three categories.

More particularly, when interacting with content (stored in a Q-A system), it is possible to qualify the questions into three categories. A question can be in-domain and complete (non-ambiguous), the question can be out-domain (also referred to as “out-of-domain”), or the question can be in-domain and incomplete (ambiguous). The question relevance detector is configured to determine a classification of the query into one the above possible categories (there may be additional categories), and may use transforms (e.g., language model vector-based transforms such as BERT) to perform the multi-class (multi-category) classification (in the above example, there are three categories). The classification mechanism may be implemented, in various examples, using lexical independent classifiers. The initial classification can be used to launch appropriate action (perform a search when the query is complete and in-domain) and avoid performing costly operations (e.g., performing a computationally expensive search when the query is ambiguous or incomplete). In various examples, the classifier may be implemented according to a machine learning model trained to classify queries of a Q-A system into the specified categories.

A query may be determined to be ambiguous for a variety of reasons. For example, a query may be ambiguous because it lacks sufficient query terms defining a coherent concept or intent, it may be ambiguous due to multi-turn processing that causes language contraction of the query, e.g., an initial query has gone through two or three turns/iterations, and something else may have been included in the previous query statement that more closely relates to the concept to be searched, or that makes the concepts covered by the current resultant query ambiguous. In the latter example a sequence of questions/statements has been reduced to a statement that is not answerable or ambiguous. Conversely, consider an example of a situation where the user submits a query of “What is the price of a MacBook Pro?” and the system returns some possible answers, to which the user, in response, submits a further query saying “How about MacBook?” In this example, the last question, although on its face is ambiguous, may nevertheless, in view of the preceding question, be sufficiently complete to be discoverable in context. The latter situation occurs frequently in dialogue systems where users may abbreviate or ask follow-up questions that are contextually connected to previous questions. Thus, a classification of questions/queries may, in example embodiments, be based on input data (provided to the classifier) that includes the latest query and one or more preceding questions/queries.

For classifiers implemented using vector transformers (e.g., BERT, ROBERTa, or other self-attention transformers) words (query terms) are replaced with tokens based on the context around them to generate a mapping that is provided to a classifier. Additional examples of transformer language models that can be used in conjunction with the classification procedure include a GPT3 language model, a T5 language model, a BART language model, an RAG language model, an UniLM language model, a Megatron language model, an ELECTRA language model, an XLNet language model, and/or an Albert language model. Based on the outcome of the classification (e.g., based on which of the three classes of in-domain, out-domain, or in-domain ambiguous, the query falls into) determined for the vector representation of the query data (transformed by a self-attention transform), different actions can be taken. For example, if the classification outcome is that the last query is in-domain ambiguous, a clarification procedure can be launched. Alternatively, the searching system may simply advise the user that the query is incomplete or cannot be run, and may ask the user to submit an alternate paraphrased query. The latter type of action avoids returning to the user non-responsive or disappointing answer responses. Consider the example where a user submits the query “How about iPhone 13?” This question is ambiguous on its own, and no helpful context is available (because, in this example, no previous query that might have provided context has been submitted by the user). Notwithstanding the ambiguity of the question, the Q-A system (that does not include a classifier/detector) may run the query against the content managed by the system, and may be able to find in the vector space content representation a document object that mentions iPhone 13, and for which a matching score has been computed (e.g., based on transform space distance) that is above a threshold used for deciding whether to return the answer to the user, but which in actuality has no relevance to what the user was looking for.

As noted, a query that in isolation may be ambiguous may actually be part a sequence of questions that provide context, and which might render the query non-ambiguous in view of the preceding questions. Accordingly, in various implementations the classifier (question relevance detector) may be configured to receive or otherwise determine relevant contextual information for a query (e.g., to obtain information on the preceding questions in the sequence of questions) and to base the classification outcome on the additional contextual information for the query.

In various examples, classification of a query may be implemented using a Bayesian inference mechanism with high probability. In such embodiments the meaning of a potentially ambiguous question may be based on what meaning was previously assigned to similarly asked-questions (by other users). That is, historical outcomes for similar questions as the current question being analyzed can be used to predict the appropriate action to take with respect to the current question/query.

In another example embodiment, out-domain (OD) detection can be implemented as follows: an N-gram based language model probabilities of a query are computed under two (2) different N-gram language models (LMs) for (1) in-domain and (2) generic-domain (representing OD). Then, some pre-defined logic, e.g., log-likelihood ratio of the two probabilities is compared to an established threshold to decide In-domain or OD based on those probabilities.

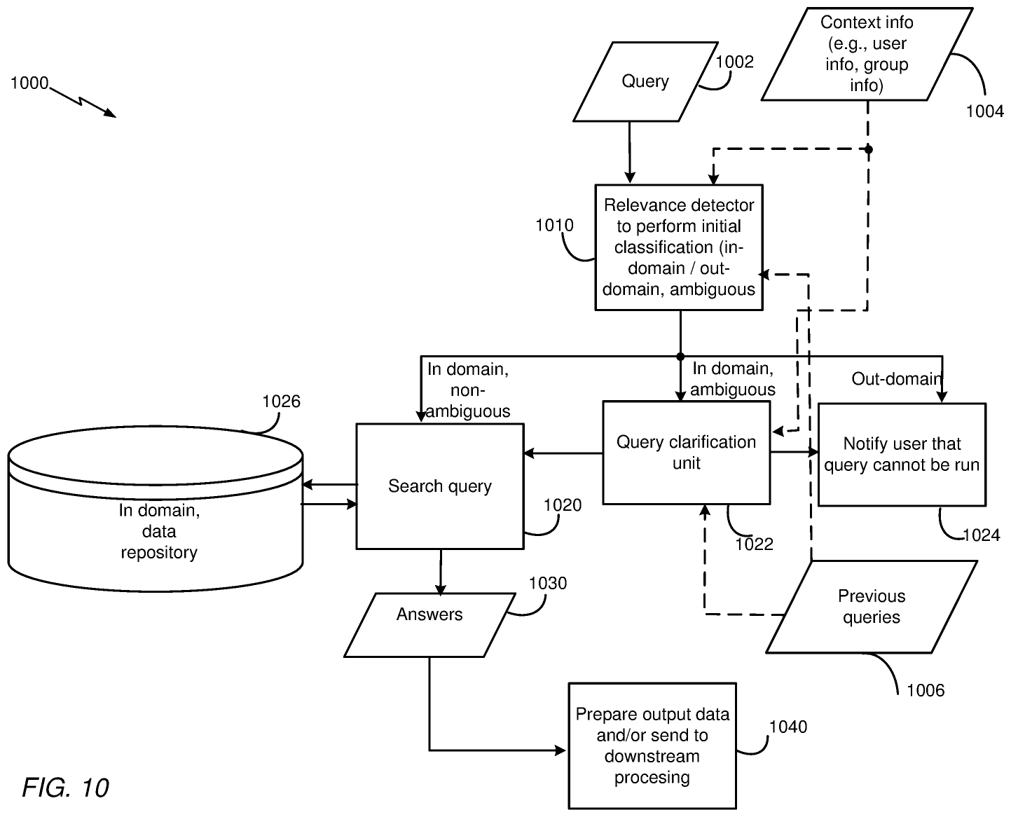

FIG. 10 is a flow diagram illustrating an example searching framework 1000 with a relevance detector configured to determine ambiguity level in a submitted query and/or determine if the submitted query is in-domain. A query may be determined to be in-domain if, for example, the query is directed to content available at the local repository coupled to the search engine, or the query is otherwise compatible with the data to be searched. A query may be determined to be out-domain if, for example, the data to be searched is not locally stored at the local repository (thus requiring remote access to another repository) or the data to be searched is not compatible with the query or the searching mechanism (e.g., the data collection to be searched pertains to a different subject matter than what the current query pertains to).

To deal with situations in which the submitted query may appear to be ambiguous (due to its terseness), but in fact the submitting user is implicitly relying on other available information (e.g., the user is submitting a conversation-style string of queries that implicitly relate to the same underlying topic or subject matter), the relevance detector 1010 obtains contextual information (provided as block 1004) and/or information about previous queries (provided in block 1006) as possible inputs to the detector. Contextual information may include all available information relevant to the query, including time information, user information, user group information, user location data, etc.) Data about the previously asked queries may include all queries submitted by the particular user, or by its associated group, during the current connectivity session between the user's network and the platform 1000.

Thus, as shown in FIG. 10, a submitted query 1002 is first provided to a relevance detector 1010, along with contextual information relating to the query or the user submitting the query and data about previously submitted queries. The relevance detector is configured to determine if the submitted query 1002 is in-domain or out-domain, and/or whether the query is ambiguous or not. In the present example, this initial classification can provide a quick determination of whether the query pertains to an in-domain unambiguous query (even if the query is a terse query that is a follow-up on an earlier query), in which case the query can be executed at the search query block 1020, whether the query is in-domain ambiguous (in which case clarification processing to generate a more complete query that does not rely on implicit information may be performed at block 1022), or whether the query is out-domain. In the event the query is determined to be out-domain, the submitting user may be informed (e.g., by block 1024) that the query cannot be run or processed. Alternatively, the query may be forwarded to another, remote, search agent where it may be run, or the local search agent may attempt to access a remote repository maintaining data pertaining to the out-domain subject matter that the query 1002 is related to.

In various examples, the relevance detector may classify the submitted query 1002 into additional classes. For instance, the relevance detector may further classify a query determined to be out-domain as being ambiguous out-domain query, or a non-ambiguous out-domain query. Here too, the specific follow-up action may depend on the classification and on the specific functionality of the platform. A classification of out-domain ambiguous may either cause the return of a notification advising the user that the query could not be performed, while a classification of out-domain non-ambiguous can cause the relevance detector to hand the non-ambiguous query to another (e.g., remote) searching agent.

As noted, the initial classification of a query, by the relevance detector, into its various classes can be performed using a transform-based classifier (i.e., a classifier in which the input is converted into an embedding/vector space, and based on the transformed vector a predicted output is generated). The transform-based classifier can be implemented according to one or more of the various language-model transforms (e.g., BERT, ROBERTa, etc., discussed herein). For the purpose of illustration, in the example of FIG. 10 the input query is classified into the three classes of in-domain, ambiguous, in-domain unambiguous, and out-domain. In some embodiments, the relevance detector may be implemented using multiple language model transforms, that separately (and independently) compute a metric indicative of which of some (or all) of the various output classes the present submitted query belongs to. For example, the relevance detector 1010 may compute an N-gram based language model in-domain probability and a generic domain probability based on the query (and optionally the contextual information). Based on those computed probabilities the relevance detector 1010 derives a metric (such as a log-likelihood ratio of the two probabilities), and determines based on that derived metric whether the query is an in-domain or out-domain query (according to a machine learning model applied to the derived metric and/or other inputs, or by using a rule-engine applied to the metric, e.g., comparing the metric to some pre-determined threshold).

With continued reference to FIG. 10, if the relevance detector 1010 determines that the query is in-domain non-ambiguous, the query (possibly modified to re-word the query based on the contextual information and/or the previous queries) is provided to the search query block 1020 (which may be implemented as part of the query processing module 136 of the example document processing agent 110 of FIG. 1) which executes the query in a manner similar to that discussed herein in relation to the query processing module 136, the process query block 410, the search block 680, or the search query block 810 of FIGS. 1, 4, 6, and 8, respectively. Thus, for example, the search query block 1020 performs one or more machine learning vector transformation operations to transform the query (be it the original or a modified query that adds to the query any implicit information, such as missing words found in preceding queries submitted by the user) into a vector space compatible with the transformed content stored in the repository to be searched. In some embodiments, and as will be discussed in greater detail below, the search query block 1020 may be configured to first perform a coarse vector transformation, based on a BERT model or one of the other models discussed herein, followed by a fine-detailed transform to search the coarse-detail search results. The search query box 1020 performs a search of the content repository 1026 that includes in-domain data collections (the content repository 1026 may be implemented similarly to the repository 140 of FIG. 1) to identify matches between the transformed query and the content arranged in the repository. The execution of the search returns answers 1030, which may include answers presented in semantic form, a particular visual form, and/or the vector-transformed form.

The identified answers in block 1030 may be those portions of the content being searched that satisfy a minimal matching criterion (for example, the identified answers are those with a relevance score exceeding some pre-determined threshold). As noted above (e.g., in relation to FIG. 4) relevance/matching scores may be computed, for example, according to a distance measurements between semantic content of an answer and a corresponding question, according to a predicted output of a trained machine learning engine that assesses relevance of a question and a candidate answer, according to a computed Transform-Based-Distance (TBD) score between a question and an answer, according to a posterior probability equivalent of the TBD, or according to any other relevance score-computing process. A particular question and answer pair with a high relevance score indicates a likelihood of a match between the query submitted and the content searched.

The returned answers may be processed to remove answers that fail to meet a certain scoring threshold, or to execute any other process such as those discussed in relation to the various search time operations described in the present disclosure (drill-down, backoff searching, query modification, etc.) Optionally, in situations where the answers contain multiple valid answers (e.g., the number of answers exceeding some scoring threshold is larger than some number-of-answers threshold), a determination may be made whether an answer disambiguation process should be performed on the answers to resolve certain ambiguities in the multiple valid answers in order to reduce the number of answers that a user (or a downstream process) would need to consider. Such disambiguation processing may be similar to the disambiguation processing discusses in U.S. application Ser. No. 18/083,733. Resultant processed answers are then forwarded to block 1040 that prepares output data from the resultant processed answers, or sends the resultant processed answers to downstream processing.

As further illustrated in FIG. 10, in the event that the question is overly ambiguous (because it is overly terse, and relies implicitly on earlier questions and contextual information), the relevance detector 1010 may still have enough information to determine, based on the ambiguous query, the contextual information 1004, and the previous queries 1006 (that imply the subject matter of the query 1002), some or all of which may be provided as input to the relevance detector 1010, to make the initial determination of whether the query 1002 is in-domain or out-domain. If the query is determined (based on the available information, including the contextual information for the query, user, group of users, etc., and one or more of the preceding queries) to be in-domain, but ambiguous, the query is forward to the query clarification unit 1022 to construct, based on the contextual information, one or more of the preceding queries, and, optionally, further user input (interactively prompting clarification from the user about what particular information the user is looking for). With reference to the above MacBook example, if the query analyzed by the query clarification unit 1022 is “How about MacBook?,” the Query clarification unit 1022 determines (using a rule-based engine, or a machine learning model) that the “how about” wording is a semantic follow-up of a previous question such as “what is the price of MacBook Pro?” that requires repeating of the same question, but with respect to a different object. Thus, the query clarification unit 1022 replaces, in this example, the ambiguous question “how about MacBook?” with “what is the price of a MacBook?” If, on the other hand, the query clarification unit cannot construct a sufficiently non-ambiguous question (the query clarification unit 1022 may additionally generate confidence or ambiguity scores to represent a confidence level that a query constructed by the query clarification unit 1022 is non-ambiguous, and compare those scores to a threshold reference value), the query clarification unit 1022 may send a notification to the user (at the block 1024) that the query cannot be run.

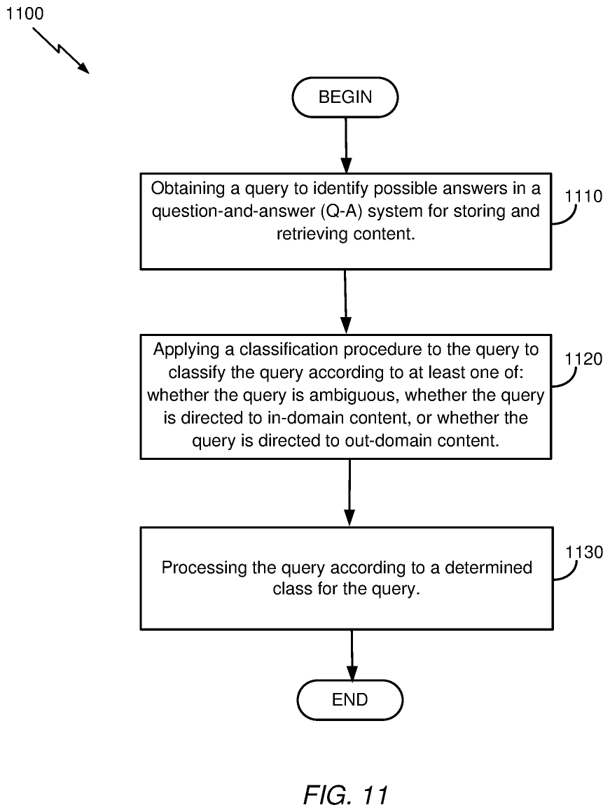

With reference next to FIG. 11, a flowchart of an example query analysis and execution procedure 1100 is shown. The procedure 1100 includes obtaining 1110 a query to identify possible answers in a question-and-answer (Q-A) system for storing and retrieving content, and applying 1120 a classification procedure to the query to classify the query according to at least one of, for example, whether the query is ambiguous, whether the query is directed to in-domain content, and/or whether the query is directed to out-domain content. The procedure 1100 further includes processing 1130 the query according to a determined class for the query.

In various examples, applying the classification procedure may include transforming the query into a query vector representation according to a language model transform (e.g., BERET, ROBERTa, or any other language model transform), and classifying the query vector representation into one of a plurality of classes. In some other examples, applying the classification procedure to the query may include computing in-domain and generic domain probabilities for the query under two or more different N-gram language models, deriving a metric based on the computed probabilities, and determining whether the query is an in-domain or out-domain query based on the derived metric. In such embodiments, deriving the metric may include deriving a log-likelihood ratio of the in-domain and generic probabilities. Determining whether the query is an out-domain query may include comparing the derived metric to a pre-established out-domain threshold.

Applying the classification procedure may include applying a machine learning classification procedure to the query. In some examples, applying the classification procedure may include determining contextual information for the query, and applying the classification procedure based on the query and the contextual information. In such examples, the contextual information may include at least one of, for example, one or more preceding queries submitted to the Q-A system, contextual data associated to the query, and/or contextual data associated with a user submitting the query.

Processing the query may include obtaining, in response to a determination that the query is classified as being in-domain and ambiguous, clarification information to reduce ambiguity of the query. In various implementations, processing the query may include performing a searching operation for the query in response to a determination that the query is classified as being non-ambiguous and directed to in-domain content.

### 7 Additional Embodiments

In implementations based on learning machines, different types of learning architectures, configurations, and/or implementation approaches may be used. Examples of learning machines include neural networks, including convolutional neural network (CNN), feed-forward neural networks, recurrent neural networks (RNN), etc. Feed-forward networks include one or more layers of nodes (“neurons” or “learning elements”) with connections to one or more portions of the input data. In a feedforward network, the connectivity of the inputs and layers of nodes is such that input data and intermediate data propagate in a forward direction towards the network's output. There are typically no feedback loops or cycles in the configuration/structure of the feed-forward network. Convolutional layers allow a network to efficiently learn features by applying the same learned transformation(s) to subsections of the data. Other examples of learning engine approaches/architectures that may be used include generating an auto-encoder and using a dense layer of the network to correlate with probability for a future event through a support vector machine, constructing a regression or classification neural network model that indicates a specific output from data (based on training reflective of correlation between similar records and the output that is to be identified), etc.

The neural networks (and other network configurations and implementations for realizing the various procedures and operations described herein) can be implemented on any computing platform, including computing platforms that include one or more microprocessors, microcontrollers, and/or digital signal processors that provide processing functionality, as well as other computation and control functionality. The computing platform can include one or more CPU's, one or more graphics processing units (GPU's, such as NVIDIA GPU's, which can be programmed according to, for example, a CUDA C platform), and may also include special purpose logic circuitry, e.g., an FPGA (field programmable gate array), an ASIC (application-specific integrated circuit), a DSP processor, an accelerated processing unit (APU), an application processor, customized dedicated circuitry, etc., to implement, at least in part, the processes and functionality for the neural network, processes, and methods described herein. The computing platforms used to implement the neural networks typically also include memory for storing data and software instructions for executing programmed functionality within the device. Generally speaking, a computer accessible storage medium may include any non-transitory storage media accessible by a computer during use to provide instructions and/or data to the computer. For example, a computer accessible storage medium may include storage media such as magnetic or optical disks and semiconductor (solid-state) memories, DRAM, SRAM, etc.

The various learning processes implemented through use of the neural networks described herein may be configured or programmed using TensorFlow (an open-source software library used for machine learning applications such as neural networks). Other programming platforms that can be employed include keras (an open-source neural network library) building blocks, NumPy (an open-source programming library useful for realizing modules to process arrays) building blocks, etc.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or ±0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or ±0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

Although particular embodiments have been disclosed herein in detail, this has been done by way of example for purposes of illustration only, and is not intended to be limit the scope of the invention, which is defined by the scope of the appended claims. Any of the features of the disclosed embodiments described herein can be combined with each other, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method comprising:
determining by a searching system, at a first time instance, one or more first search results for a first query comprising one or more query terms associated with a first concept;
modifying the query, based on the determined one or more first search results, to include one or more modified query terms associated with one or more concepts hierarchically related to the first concept, including determining, based on a machine learning hierarchical concept-identifying model configured to generate resulting labels defined in a hierarchical ontology, the one or more hierarchical concepts from the hierarchical ontology in response to the first query; and
determining at a subsequent time instance one or more subsequent search results for the modified query comprising the one or more modified query terms.

2. The method of claim 1, wherein the first concept and the hierarchically related one or more concepts are arranged in an ontology.

3. The method of claim 1, wherein modifying the query comprises:
including in the modified query revised query terms to cause the searching system to search content directed to a broader concept that is at a parental hierarchical level in relation to the first concept.

4. The method of claim 3, wherein modifying the query comprises:
modifying the query to include the revised query terms directed to the broader concept in response to a determination that fewer than a threshold number of respective one or more answer scores computed for the one or more first search results exceed a score threshold representative of a satisfactory answer.

5. The method of claim 1, wherein modifying the query comprises:
including in the modified query revised one or more terms to cause the searching system to search for content directed to one or more child concepts that are at a child hierarchical level in relation to the first concept.

6. The method of claim 1, further comprising:
presenting to a user multiple search results for the first query;
wherein modifying the query comprises modifying the query to include drilled-down query terms determined for one of the multiple search results selected by the user.

7. The method of claim 6, wherein the drilled-down query terms are directed to concepts at a lower hierarchical level than the first concept.

8. The method of claim 7, further comprising:
determining after obtaining the one or more subsequent search results for the modified query whether to re-present the multiple search results for the first query or to further modify the modified query based on further drilled down concepts at a child hierarchical level of the lower hierarchical level.

9. The method of claim 6, wherein presenting to the user the multiple search results for the first query comprises:
identifying multiple question-answer pairs relevant to the first query that are additionally associated with concepts at a next lower hierarchical level than the first concept; and
presenting to the user at least some of the multiple question-answer pairs;
wherein modifying the query to include drilled-down query terms comprises modifying the query based on a question portion of a question-answer pair selected from the at least some of the multiple question-answer pairs.

10. The method of claim 1, further comprising:
iteratively repeating the modifying and determining of search results based on answer scores computed for respective search results in search iterations.

11. The method of claim 1, wherein determining the one or more hierarchical concepts comprises:
generating, according to a machine learning concept-identifying model located upstream to the machine learning hierarchical concept-identifying model, one or more labels representative of the first concept associated with the query; and
processing the one or more generated labels using the machine learning hierarchical concept-identifying model to determine the one or more hierarchical concepts.

12. The method of claim 1, wherein modifying the query comprises:
identifying one or more ambiguity categories associated with multiple matches from the one or more first search results, at least one of the one or more identified ambiguity categories being associated with at least some of the multiple matches and including different respective values associated with the at least some of the multiple matches;
obtaining disambiguation information relevant to the at least one of the one or more identified ambiguity categories; and
selecting at least one of the multiple matches based on the obtained disambiguation information relevant to the at least one of the one or more identified ambiguity categories.

13. The method of claim 12, wherein obtaining the disambiguation information comprises one or more of:
obtaining query contextual information for the first query; or
generating prompt data to prompt a user to provide clarification information;
and wherein selecting at least one of the multiple matches comprises selecting at least one of the multiple matches based, at least in part, on the query contextual information and/or on the clarification information provided by the user in response to the generated prompt data.

14. A method comprising:
determining by a searching system, at a first time instance, one or more first search results for a first query comprising one or more query terms associated with a first concept;
modifying the query, based on the determined one or more first search results, to include one or more modified query terms associated with one or more concepts hierarchically related to the first concept;
wherein modifying the query comprises
identifying one or more ambiguity categories associated with multiple matches from the one or more first search results, at least one of the one or more identified ambiguity categories being associated with at least some of the multiple matches and including different respective values associated with the at least some of the multiple matches,
obtaining disambiguation information relevant to the at least one of the one or more identified ambiguity categories, and
selecting at least one of the multiple matches based on the obtained disambiguation information relevant to the at least one of the one or more identified ambiguity categories; and
determining at a subsequent time instance one or more subsequent search results for the modified query comprising the one or more modified query terms.

15. The method of claim 14, wherein the first concept and the hierarchically related one or more concepts are arranged in an ontology.

16. The method of claim 14, wherein modifying the query comprises:
including in the modified query revised query terms to cause the searching system to search content directed to a broader concept that is at a parental hierarchical level in relation to the first concept.

17. The method of claim 16, wherein modifying the query comprises:
modifying the query to include the revised query terms directed to the broader concept in response to a determination that fewer than a threshold number of respective one or more answer scores computed for the one or more first search results exceed a score threshold representative of a satisfactory answer.

18. The method of claim 14, wherein modifying the query comprises:
including in the modified query revised one or more terms to cause the searching system to search for content directed to one or more child concepts that are at a child hierarchical level in relation to the first concept.

19. The method of claim 14, further comprising:
presenting to a user multiple search results for the first query;
wherein modifying the query comprises modifying the query to include drilled-down query terms determined for one of the multiple search results selected by the user.

20. The method of claim 19, wherein the drilled-down query terms are directed to concepts at a lower hierarchical level than the first concept.

21. The method of claim 20, further comprising:
determining after obtaining the one or more subsequent search results for the modified query whether to re-present the multiple search results for the first query or to further modify the modified query based on further drilled down concepts at a child hierarchical level of the lower hierarchical level.

22. The method of claim 19, wherein presenting to the user the multiple search results for the first query comprises:
identifying multiple question-answer pairs relevant to the first query that are additionally associated with concepts at a next lower hierarchical level than the first concept; and
presenting to the user at least some of the multiple question-answer pairs;
wherein modifying the query to include drilled-down query terms comprises modifying the query based on a question portion of a question-answer pair selected from the at least some of the multiple question-answer pairs.

23. The method of claim 14, further comprising:
iteratively repeating the modifying and determining of search results based on answer scores computed for respective search results in search iterations.

24. The method of claim 14, wherein modifying the query comprises:
determining, based on a machine learning hierarchical concept-identifying model configured to generate resulting labels defined in a hierarchical ontology, the one or more hierarchical concepts from the hierarchical ontology in response to the first query.

25. The method of claim 24, wherein determining the one or more hierarchical concepts comprises:
generating, according to a machine learning concept-identifying model located upstream to the machine learning hierarchical concept-identifying model, one or more labels representative of the first concept associated with the query; and
processing the one or more generated labels using the machine learning hierarchical concept-identifying model to determine the one or more hierarchical concepts.

26. The method of claim 14, wherein modifying the query comprises:
identifying one or more ambiguity categories associated with multiple matches from the one or more first search results, at least one of the one or more identified ambiguity categories being associated with at least some of the multiple matches and including different respective values associated with the at least some of the multiple matches;
obtaining disambiguation information relevant to the at least one of the one or more identified ambiguity categories; and
selecting at least one of the multiple matches based on the obtained disambiguation information relevant to the at least one of the one or more identified ambiguity categories.

27. The method of claim 26, wherein obtaining the disambiguation information comprises one or more of:
obtaining query contextual information for the first query; or
generating prompt data to prompt a user to provide clarification information;
and wherein selecting at least one of the multiple matches comprises selecting at least one of the multiple matches based, at least in part, on the query contextual information and/or on the clarification information provided by the user in response to the generated prompt data.
